(19) United States
(12) Patent Application Publication
(10) Pub. No.: US 2025/0016875 A1
(43) Pub. Date: Jan. 9, 2025

(54) DISCONTINUOUS RECEPTION MODE COMMUNICATION TECHNIQUES

(71) Applicant: QUALCOMM INCORPORATED, San Diego, CA (US)

(72) Inventors: Zhichao Zhou, Beijing (CN); Ravi Agarwal, San Diego, CA (US); Hao Xu, Beijing (CN)

(21) Appl. No.: 18/712,228

(22) PCT Filed: Jan. 26, 2022
(86) PCT No.: PCT/CN2022/073900

§ 371 Date: May 21, 2024

(51) Int. Cl. H04W 76/28; H04W 72/0446

(52) U.S. Cl. CPC H04W 76/28; H04W 72/0446

(57) ABSTRACT

Methods, systems, and devices for wireless communications are described. A user equipment (UE may be configured to communicate with a base station in a discontinuous reception (DRX) mode according to a DRX cycle. The UE may receive signaling that indicates a configuration of a ramp window associated with the DRX cycle. The ramp window may include a set of slots that is adjacent to a sleep window of the DRX cycle and, in some examples, is adjacent to an on-window of the DRX cycle. The set of slots may include a first subset of wakeup slots and a second subset of sleep slots. During the ramp window, the UE may monitor for a transport block from the base station during the first subset of wakeup slots. If the UE receives the transport block during a wakeup slot, the UE may transition to the on-window of the DRX cycle.

### CROSS REFERENCE

The present Application is a 371 national stage filing of International PCT Application No. PCT/CN2022/073900 by Zhou et al. entitled “DISCONTINUOUS RECEPTION MODE COMMUNICATION TECHNIQUES,” filed Jan. 26, 2022, which is assigned to the assignee hereof, and which is expressly incorporated by reference in its entirety herein.

### FIELD OF TECHNOLOGY

The following relates to wireless communications, including discontinuous reception (DRX) mode communication techniques.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may communicate in accordance with a discontinuous reception (DRX) cycle in which the UE transitions between an on-state and a sleep state. In some cases, various delays (e.g., processing delays, transmission delays) may cause a message to arrive at the UE outside of period in which the UE is in the on-state, thereby causing the UE to miss reception of the message.

### SUMMARY

The described techniques relate to improved methods, systems, devices, and apparatuses that support discontinuous reception (DRX) mode communication techniques. Generally, the described techniques enable the reception of a transport block that arrives outside of an on-window of a DRX cycle. For example, a user equipment (UE) and a base station may be configured to communicate according to a DRX cycle during which the UE may transition between an on-state and a sleep state to conserve power. The UE may be in the on-state during an on-window of the DRX cycle and may be in the sleep state during a sleep window of the DRX cycle. The base station may schedule downlink transmissions (e.g., a transport block transmitted to the UE) during the on-window of the DRX cycle so that the UE may be able to receive and decode the downlink transmissions. In some cases, however, an arrival time of a transport block may fluctuate dynamically, for example, due to dynamic variations in processing delays, transmitting delays, and the like. Such arrival time fluctuation may cause a transport block scheduled for reception within the on-window to arrive outside of (e.g., before or after) the on-window.

To enable reception of the transport block, the UE may be configured with one or more ramp windows that include (e.g., span) wakeup slots and sleep slots. For example, the base station may transmit signaling that indicates a configuration for a ramp window that includes a subset of wakeup slots and a subset of sleep slots within the ramp window. The ramp window may be outside of (e.g., adjacent to) the sleep window of the DRX cycle and, in some examples, may be adjacent to the on-window of the DRX cycle (e.g., before or after the on-window). The UE may be configured to be in (e.g., transition to) the on-state during the wakeup slots of the ramp window and be in (e.g., transition to) the sleep state during the sleep slots of the ramp window. Accordingly, if the transport block arrives during a wakeup slot of the ramp window, the UE may be able to receive and decode the transport block. Thus, the configuration of and monitoring in accordance with a ramp window may enable a UE to receive a transport block that would otherwise be missed due to arrival time fluctuation.

### BRIEF DESCRIPTION OF THE DRAWINGS

FIGS. 1 and 2 illustrate examples of wireless communications systems that supports discontinuous reception (DRX) mode communication techniques in accordance with aspects of the present disclosure.

FIG. 3 illustrates an example of a communication diagram that supports DRX mode communication techniques in accordance with aspects of the present disclosure.

FIGS. 4, 5, 6, and 7 illustrate examples of DRX cycle diagrams that supports DRX mode communication techniques in accordance with aspects of the present disclosure.

FIG. 8 illustrates an example of a process flow that supports DRX mode communication techniques in accordance with aspects of the present disclosure.

FIGS. 9 and 10 show block diagrams of devices that support DRX mode communication techniques in accordance with aspects of the present disclosure.

FIG. 11 shows a block diagram of a communications manager that supports DRX mode communication techniques in accordance with aspects of the present disclosure.

FIG. 12 shows a diagram of a system including a device that supports DRX mode communication techniques in accordance with aspects of the present disclosure.

FIGS. 13 through 15 show flowcharts illustrating methods that support DRX mode communication techniques in accordance with aspects of the present disclosure.

### DETAILED DESCRIPTION

Some wireless communications systems may include communication devices, such as a user equipment (UE) and a base station (e.g., an eNodeB (eNB), a next-generation NodeB or a giga-NodeB, either of which may be referred to as a gNB, or some other base station), that may support multiple radio access technologies. In some examples, a UE may be configured to communicate with a base station while operating in a discontinuous reception (DRX) mode (e.g., connected mode DRX (CDRX)) in accordance with a DRX cycle. For example, a UE operating in a DRX mode may communicate with a base station according to repeating DRX cycles that include a window of time during which the UE is in an on-state (e.g., an on-window) and a window of time during which the UE is in a sleep state (e.g., a sleep window). While in the on-state, the UE may be able to communicate messages with the base station. While in the sleep state, the UE may power down one or more components of the UE to conserve power and may be unable to communicate with the base station.

During the on-window of the DRX cycle, the UE may monitor for transport blocks transmitted by the base station, where a transport block may correspond to a packet of information (e.g., data, control information) that is passed between a medium access control (MAC) layer and a physical layer. If the UE receives a transport block during the on-window, the UE may remain in the on-state and communicate with the base station until an expiration of a DRX-inactivity timer, at which point the UE may transition to the sleep state for a duration of the sleep window. If the UE does not receive a transport block during the on-window, the UE may transition to the sleep state for the duration of the sleep window until a next on-window of a next DRX cycle.

The base station may schedule transport blocks during an on-window of a DRX cycle so that the UE may be able to receive and decode the transport block. In some cases, however, a transport block may experience jitter, for example, due to dynamic variations in processing delays, transmitting delays, and the like, where jitter corresponds to a difference between an arrival time of a transport block (e.g., a downlink transport block, an uplink transport block) and a scheduled reception time of the transport block. That is, a jittered transport block may arrive at a time different from the scheduled arrival time. In some cases, jitter may be large enough such that a transport block scheduled for reception within an on-window arrives outside of (e.g., before or after) the on-window. As a result, the UE may be in a sleep state when the transport block arrives and may thus miss reception of the transport block, which may increase latency associated with communication of the transport block. For example, the UE may transition to the sleep state during the sleep window following the on-window based on missing the transport block and may wait until a subsequent on-window of a subsequent DRX cycle to receive a retransmission of the transport block (e.g., and corresponding messages scheduled by the transport block).

Techniques, systems, and devices are described herein to enable the reception of a transport block that arrives outside of an on-window of a DRX cycle. For example, a UE may be configured with one or more ramp windows that include (e.g., span) wakeup slots and sleep slots. For instance, a base station may transmit signaling that indicates a configuration for a ramp window that includes a subset of wakeup slots and a subset of sleep slots within the ramp window. The ramp window may be outside of (e.g., adjacent to) a sleep window of the DRX cycle and, in some examples, may be outside of (e.g., adjacent to) the on-window of the DRX cycle. That is, the ramp window may be a window of time within the DRX cycle that is different from one or both of the on-window and the sleep window. The UE may be configured to be in the on-state during the wakeup slots and in the sleep state during the sleep slots of the ramp window. Accordingly, the UE may be able to receive and decode a transport block transmitted by the base station that arrives during a wakeup slot of the ramp window.

The UE may monitor for a transport block from the base station during the wakeup slots of the ramp window. In some examples, the transport block may experience jitter such that the transport block arrives during the ramp window instead of the on-window of the DRX cycle. If the jittered transport block arrives during a wakeup slot of the ramp window, the UE may receive and decode the transport block and may transition to the on-window of the DRX cycle. Otherwise, if the ramp window occurs before the on-window and the UE does not receive the transport block during the ramp window, the UE may transition to the on-window after the ramp-window. Alternatively, if the ramp window occurs after the on-window and the UE does not receive the transport block during the ramp window, the UE may transition to the sleep window after the ramp window.

Aspects of the subject matter described in this disclosure may be implemented to realize one or more of the following potential improvements, among others. The techniques employed by the described communication devices may enable reception of a transport block that would otherwise be missed by a UE communicating in accordance with a DRX cycle. For example, monitoring for a transport block in accordance with a configured ramp window may enable the UE to receive a jittered transport block that arrives outside of an on-window of the DRX cycle and within a wakeup slot of the ramp window. Receiving a jittered transport block may reduce latency, increase data rates, and improve resource usage efficiency, for example, by eliminating the delay and communication of signaling associated with retransmitting the jittered transport block that would have otherwise been missed (e.g., the retransmission of the jittered transport block, feedback signaling associated with missing the jittered transport block). Additionally, monitoring for transport blocks in accordance with a ramp window may reduce power consumption. For example, the ramp window may increase a duration of a DRX cycle during which the UE is capable of receiving and decoding transport blocks while reducing power consumption relative to merely increasing a duration of an on-window of the DRX cycle. For instance, the UE may be in an on-state for the entire duration of the on-window, while the UE may transition between the on-state and a sleep state during the ramp window. Thus, a ramp window spanning a same quantity of slots as an on-window may be associated with less power consumption that the on-window. Further, in some examples, the ramp window may replace the on-window in the DRX cycle, thereby reducing power consumption associated with communicating according to the DRX cycle. In some examples, ramp window monitoring may improve coordination between communication devices and increase battery life, among other benefits.

Aspects of the disclosure are initially described in the context of wireless communications systems. Aspects of the disclosure are additionally described in the context of a communication diagram, DRX cycle diagrams, and a process flow. Aspects of the disclosure are further illustrated by and described with reference to apparatus diagrams, system diagrams, and flowcharts that relate to DRX mode communication techniques.

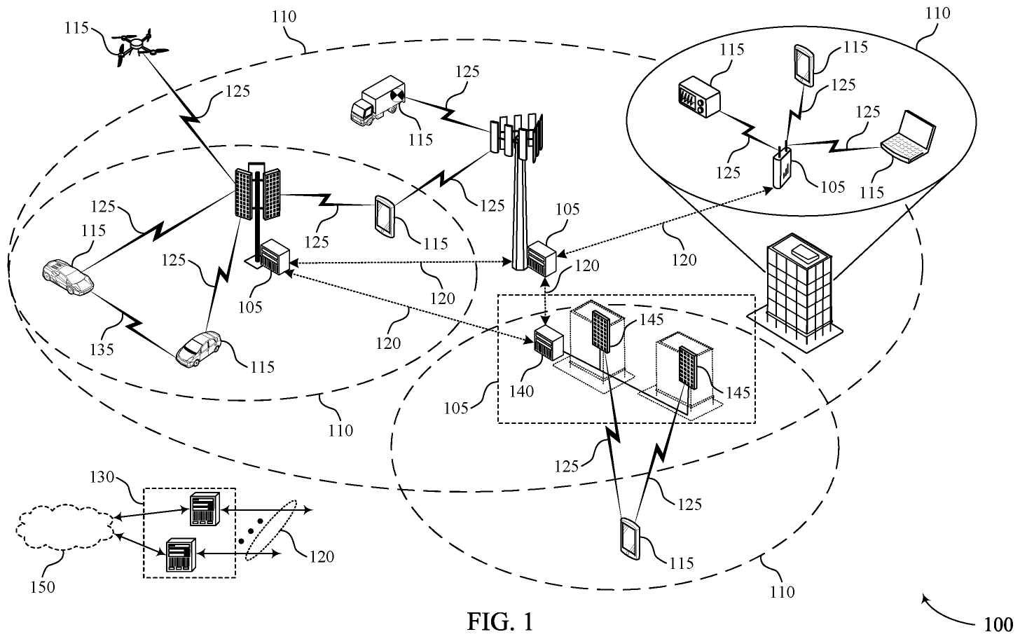

FIG. 1 illustrates an example of a wireless communications system 100 that supports DRX mode communication techniques in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(fₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

A DRX mode may be an example of an operating mode that reduces power consumption. For example, while operating in a DRX mode, a UE 115 may communicate with a base station 105 according to a DRX cycle (e.g., repeating DRX cycles). The DRX cycle may include periods of time during which the UE 115 is in an on-state and periods of time during which the UE 115 is in a sleep state. For example, the DRX cycle may include an on-window during which the UE 115 is in the on-state and is thus able to communicate with the base station 105. The DRX may also include a sleep-window during which the UE 115 is in the sleep state and may power down one or more components of the UE 115 to conserve power. Thus, the UE 115 may be unable to communicate with the base station 105 while in the sleep state.

The UE 115 may be configured with DRX parameters that indicate various parameters of the DRX cycle. For example, a base station 105 may indicate (e.g., via RRC signaling) a duration of the DRX cycle, a duration of the on-window (e.g., an onDurationTimer value), a duration of the sleep window (e.g., which may be implicit based on the duration of the DRX cycle and the duration of the on-window), a duration of a DRX-inactivity timer, a duration of a DRX-retransmission timer, a duration of a short DRX cycle, a duration of a DRX-short cycle timer, or a combination thereof. The duration of the DRX-inactivity timer may indicate for how the long the UE 115 to remain in the on-state after reception of a transport block. In some cases, the time during which the UE 115 is in the on-state may extend into the sleep window based on the DRX-inactivity timer. For example, if the UE 115 receives a transport block during the on-window, the UE 115 may initiate the DRX-inactivity timer. Depending on when the UE 115 receives with the transport block within the on-window, the DRX-inactivity timer may expire after an end of the on-window, and the UE 115 may remain in the on-state until the DRX-inactivity timer expires (e.g., rather than until the end of the on-window) and transition to the sleep window upon expiration of the DRX-inactivity timer. In some examples, the UE 115 may restart the DRX-inactivity timer each time that a transport block is communicated between the UE 115 and the base station 105 or each time that a transport block is received from the base station 105.

The duration of the DRX-retransmission timer may indicate a quantity of consecutive physical downlink control channel (PDCCH) subframes after a first available retransmission time for the UE 115 to remain in the on-state to wait an incoming PDCCH retransmission.

In some examples, the UE 115 may be configured with a short DRX cycle. In some cases, the short DRX cycle may correspond to a shorter duration DRX cycle that may occur one or more times after an expiration of the DRX-inactivity timer. For example, after expiration of the DRX-inactivity timer, the UE 115 may be configured to communicate according to the short DRX cycle for one or more cycles before switching back to communicating according to the DRX cycle (which may be referred to here as a long DRX cycle). The duration of the short DRX cycle may be less than the duration of the DRX cycle and may have be associated with a smaller sleep window. The duration of the DRX-short cycle timer may indicate the number of short DRX cycles following the DRX-inactivity timer expiration, for example, by indicating a consecutive number of subframes for which the UE 115 is to communicate according the short DRX cycle.

A base station 105 may schedule communications with a UE 115 in accordance with a DRX cycle of the UE 115. For example, the base station 105 may schedule the transmission of transport blocks to the UE 115 during an on-window of the DRX cycle so that the UE 115 may be able receive and decode the transport blocks. In some cases, however, a transport block may experience jitter and arrive before or after a scheduled arrival time of the transport block. For example, jitter may be caused by dynamically varying traffic latency. Traffic latency may be based on a processing delay of a transport block, a transmitting delay of the transport block, or a combination thereof. The processing delay and the transmitting delay may vary based on processing hardware (e.g., of the UE 115, of the base station 105), traffic volume (e.g., queueing delay), a number of UEs 115 served by the base station 105 at a same time, a channel quality of a channel (e.g., a communication link 125) between the UE 115 and the base station 105, or a combination thereof. Accordingly, based on the processing delay and transmitting delay associated with a transport block, the transport block may arrive before, during, or after a scheduled arrival time of the transport block. In some cases, jitter of a transport block may cause the transport block to arrive outside of the on-window of the DRX cycle, thereby causing the UE 115 to miss the transport block.

To reduce or mitigate the effects of jitter, a UE 115 may be configured with a ramp window during a DRX cycle. The ramp window may be outside of (e.g., adjacent to) the on-window and a sleep window of the DRX cycle. The ramp window may include a subset of wakeup slots and a subset of sleep slots. The UE 115 may be in an on-state during the wakeup slots of the ramp window and thus may be able to receive a transport block that arrives during a wakeup slot of the ramp window. Accordingly, by including the ramp window within the DRX cycle, the UE 115 may be able to monitor for and receive transport blocks that arrive outside of the on-window of the DRX cycle.

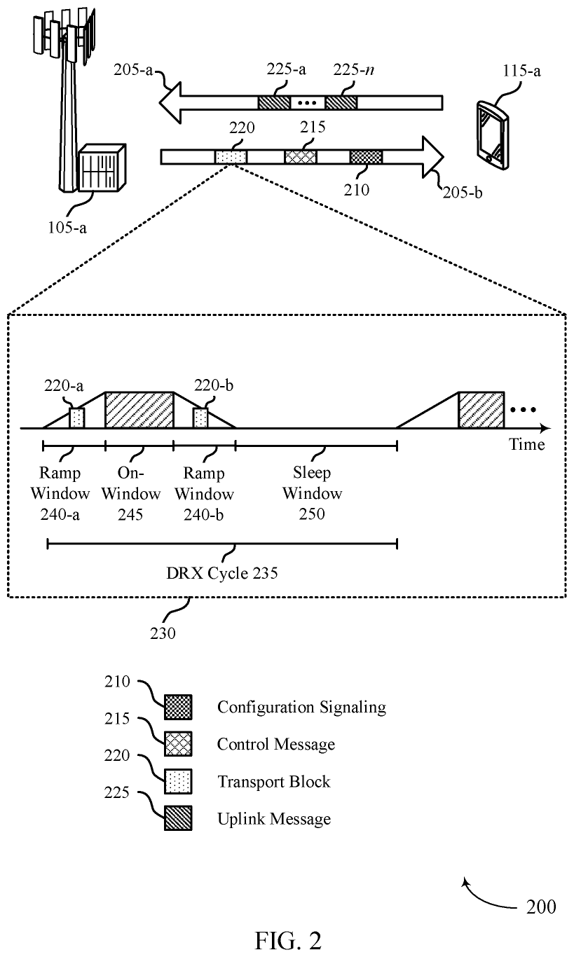

FIG. 2 illustrates an example of a wireless communications system 200 that supports DRX mode communication techniques in accordance with aspects of the present disclosure. The wireless communications system 200 may implement or be implemented by aspects of the wireless communications system 100 described with reference to FIG. 1. For example, the wireless communications system 200 may include a base station 105-a and a UE 115-a, which may be examples of the corresponding devices described with reference to FIG. 1. The wireless communications system 200 may support ramp window configurations for DRX cycles, which may provide improvements to latency, power consumption, data rates, battery life, and coordination between devices, among other benefits.

The wireless communications system 200 may support communications between the base station 105-a and the UE 115-a. For example, the base station 105-a may transmit downlink messages to the UE 115-a over a communication link 205-a, and the UE 115-a may transmit uplink messages to the base station 105-a over communication link 205-b. The communication links 205 may be examples of a communication link 125 described with reference to FIG. 1.

The wireless communications system 200 may support DRX mode operations. For example, the UE 115-a may be configured to communicate with the base station 105-a according to a DRX cycle 235 to conserve power, among other benefits. The DRX cycle 235 may include a sleep window 250 during which the UE 115 is in a sleep state and may be unable to communicate with the base station 105-a. The DRX cycle 235 may also include one or more ramp-windows 240, an on-window 245, or both. A ramp window 240 may include (e.g., span) a set of slots that includes a subset of wakeup slots during which the UE 115-a is in an on-state and a subset of sleep slots during which the UE 115-a is in the sleep state. During the on-window 245, the UE 115-a may be in the on-state and thus may be able to communicate with the base station 105-a.

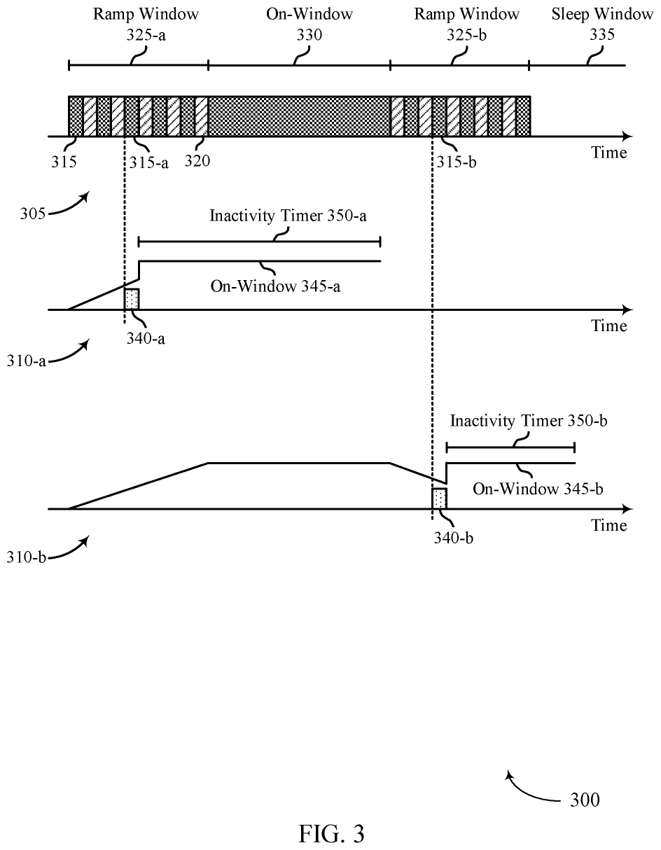

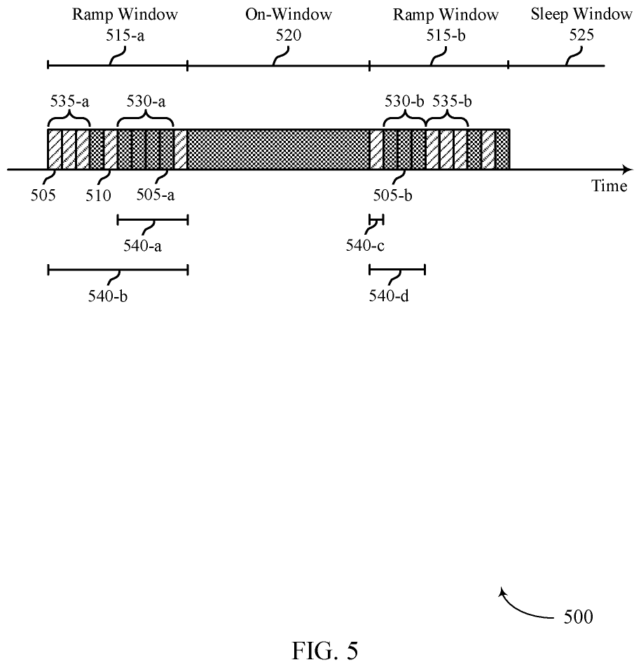

The base station 105-a may transmit configuration signaling 210 to the UE 115-a that indicates configurations for the DRX cycle 235. For example, the configuration signaling 210 may indicate a duration of the DRX cycle 235, a configuration for one or more ramp windows 240, a configuration for the on-window 245, a configuration for the sleep window 250, or a combination thereof. As described in additional detail in FIGS. 3 through 8 below, the configuration for the one or more ramp windows 240 may indicate a quantity of ramp windows 240 in the DRX cycle 235, a length of the one or more ramp windows 240 (e.g., a quantity of slots included in the one or more ramp windows 240), a quantity of wakeup slots in the one or more ramp windows 240, a quantity of sleep slots in the one or more ramp windows 240, locations of the wakeup slots within the one or more ramp windows 240, locations of the sleep slots within the one or more windows 240, or a combination thereof. In some examples, the configuration for the one or more ramp windows 240 may be based on a jitter of one or more uplink messages 225 (e.g., an uplink message 225-a through an uplink message 225-n) transmitted by the UE 115-a. For example, jitter experienced by a transport block 220 may be similar to jitter experienced by an uplink message 225 due to a reciprocity of uplink and downlink channels between the UE 115-a and the base station 105-a. Thus, a base station 105-a may be able to predict the jitter of a transport block 220 based on the jitter of an uplink message 225 and may configure quantity and location of wakeup slots within a ramp window 240 accordingly. Additional details related to configuring a ramp window 240 based on uplink jitter are described with reference to FIG. 5 below.

The configuration for the on-window 245 may indicate a duration of the on-window 245, a location of the on-window 245 within the DRX cycle 235, or both. The configuration for the sleep window 250 may indicate a duration of the sleep window 250, a location of the sleep window 250 within the DRX cycle 235, or both. In some cases, the configuration for the sleep window 250 may be implicit based on the duration of the DRX cycle 235, the configuration for the one or more ramp windows 240, the configuration for the on-window 245, or a combination thereof.

The UE 115-a may be configured to monitor for transport blocks 220 from the base station 105-a during wakeup slots of a ramp window 240 (e.g., in addition to during the on-window 245). In some examples, such monitoring may be activated or deactivated. For example, the base station 105-a may transmit a control message 215 to the UE 115-a that activates or deactivates the monitoring of transport blocks 220 during the wakeup slots of the ramp window 240. Accordingly, the UE 115-a may transition between communicating according to a DRX cycle 235 that includes one or more ramp windows 240 and a DRX cycle 235 that excludes the one or more ramp windows 240 based on whether the one or more ramp windows 240 are activated or deactivated. In some examples, the UE 115-a may receive the control message 215 in a MAC-control element (MAC-CE) or in downlink control information (DCI).

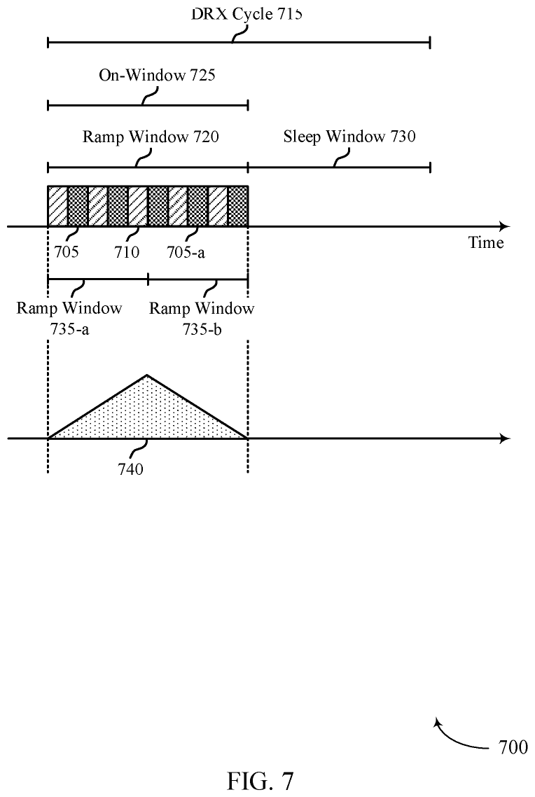

Monitoring for a transport block 220 in accordance with a configuration of a ramp window 240 may mitigate the effects of jitter that may be experienced by the transport block 220. For example, FIG. 2 depicts a communication sequence 230 in which a transport block 220 may experience jitter that causes the transport block 220 to arrive at the UE 115-a at time different from a scheduled arrival time. In the example of the communication sequence 230, the UE 115-a may be configured with a DRX cycle 235 that includes a ramp window 240-a, an on-window 245, a ramp window 240-b, and a sleep window 250. The ramp window 240-a may occur before the on-window 245 and may be adjacent in time to the on-window 245 (e.g., the on-window 245 may occur immediately after the ramp window 240-a). In some cases, the ramp window 240-a may be adjacent to a sleep window 250 of a previous DRX cycle 235. The ramp window 240-b may occur after and be adjacent in time to the on-window 245 (e.g., the on-window 245 may occur immediately before the ramp window 240-b). The ramp window 240-b may also occur before and be adjacent in time to the sleep window 250. It is noted that the communication sequence 230 depicts an example in which the UE 115-a is configured with (e.g., via the configuration signaling 210) a ramp window 240 before and after the on-window 245, however, the techniques may be adapted and applied for the UE 115-a to be configured with one ramp window 240 or no on-window 245 (e.g., for one or more ramp windows 240 to replace the on-window 245 as described with reference to FIG. 7).

In some examples, the base station 105-a may transmit a transport block 220-a that arrives before the on-window 245. For example, the transport block 220-a may be scheduled to arrive during the on-window 245 but may experience jitter such that the transport block 220-a arrives early and before the on-window 245. The jitter may cause the transport block 220-a to arrive during the ramp window 240-a, and the UE 115-a may monitor for the transport block 220-a during wakeup slots of the ramp window 240-a and be in a sleep state during sleep slots of the ramp window 240-a. If the transport block 220-a arrives at the UE 115-a during a wakeup slot of the ramp window 240-a, the UE 115-a may receive and decode the transport block 220-a based on being in the on-state during the wakeup slot. In response to receiving the transport block 220-a during the wakeup slot, the UE 115-a may transition to the on-window 245 and, in some examples, may initiate a DRX-inactivity timer (e.g., configured via the configuration signaling 210). After a duration of the on-window 245 (e.g., and the ramp window 240-b) or after an expiration of the DRX-inactivity timer, the UE 115-a may transition to the sleep window 250 and remain in the sleep state for the duration of the sleep window 250 (e.g., if no additional transport blocks 220 are received from the base station 105-a while the UE 115-a is in the on-state). Additional details related to transitioning to an on-window 245 of a DRX cycle 235 in response to receiving a transport block 220 during a ramp window 240 are described with reference to FIGS. 3 through 7 below.

In some examples, the base station 105-a may transmit a transport block 220-b that arrives after the on-window 245. For example, the transport block 220-b may be scheduled to arrive during the on-window 245 but may experience jitter (e.g., be delayed) such that the transport block 220-b arrives late and after the on-window 245. The jitter may cause the transport block 220-b to arrive during the ramp window 240-b, and the UE 115-a may monitor for the transport block 220-b during wakeup slots of the ramp window 240-b and be in a sleep state during sleep slots of the ramp window 240-b. If the transport block 220-b arrives at the UE 115-a during a wakeup slot of the ramp window 240-b, the UE 115-a may receive and decode the transport block 220-b based on being in the on-state during the wakeup slot. In response to receiving the transport block 220-b during the wakeup slot, the UE 115-a may transition to an on-window 245. For example, the UE 115-a may initiate a DRX-inactivity timer and remain in the on-state until an expiration of the DRX-inactivity timer. Here, sleep slots of the ramp window 240-b may be overridden. That is, the UE 115-a may remain in the on-state until the expiration of the DRX-inactivity timer even during the remaining sleep slots of the ramp window 240-b based on receiving the transport block 220-b during the wakeup slot. Additional details related to transitioning to an on-window 245 in response to receiving a transport block 220 during a ramp window 240 are described with reference to FIGS. 3 through 7 below. Upon expiration of the DRX-inactivity timer, the UE 115-a may transition to the sleep window 250 and remain in the sleep state for the duration of the sleep window 250 (e.g., until a next ramp window 240 or on-window 245 of a next DRX cycle 235).

By implementing monitoring in accordance with ramp windows 240, the UE 115-a may be able to receive and decode a transport block 220 that arrives outside of an on-window 245 of a DRX cycle 235. As such, latency associated with the transport block 220 may be reduced, retransmission(s) of the transport block 220 may be avoided, and power may be conserved.

FIG. 3 illustrates an example of a communication diagram 300 that supports DRX mode communication techniques in accordance with aspects of the present disclosure. The communication diagram 300 may implement or be implemented by aspects of the wireless communications system 100 and 200 as described with reference to FIGS. 1 and 2, respectively. For example, the communication diagram 300 may be implemented by a UE 115 and a base station 105 to support ramp window configurations for DRX cycles.

The communication diagram 300 depicts a DRX cycle diagram 305, which may represent an example DRX cycle that may be configured at the UE 115 by the base station 105 (e.g., via configuration signaling 210 described with reference to FIG. 2). The DRX cycle may include a ramp window 325-a and a ramp window 325-b, which may be examples of a ramp window 240-a and a ramp window 240-b described with reference to FIG. 2, respectively. The DRX cycle may also include an on-window 330 and a sleep window 335, which may be examples of an on-window 245 and a sleep window 250 described with reference to FIG. 2, respectively.

The ramp window 325-a may include (e.g., span) a first set of slots that includes wakeup slots 315 and sleep slots 320. The ramp window 325-b may include (e.g., span) a second set of slots that includes wakeup slots 315 and sleep slots 320. In the example of FIG. 3, the first set of slots of the ramp window 325-a may include a first subset of wakeup slots 315 that includes five wakeup slots 315 and a first subset of sleep slots 320 that includes five sleep slots 320. The second set of slots of the ramp window 325-b may include a second subset of wakeup slots 315 that includes five wakeup slots 315 and a second subset of sleep slots 320 that includes five sleep slots 320.

A length of a ramp window 325 may correspond to a quantity of slots included in the ramp window 325. Thus, in the example of FIG. 3, the ramp window 325-a and the ramp window 325-b may each have a length of ten slots, although such lengths are provided as examples for clarity and ramp windows 325 of any length may be configured and supported. For example, the base station 105 may configure the length of a ramp window 325 (e.g., via configuration signaling 210) based on a statistical probability that jitter will occur. For instance, the base station 105 may determine the statistical probability that a transport block 340 (e.g., a transport block 220, a downlink message) scheduled for reception during the on-window 330 is received (e.g., will arrive) outside of the on-window 330 and may configure the quantity of slots included in the ramp windows 325 (e.g., included in the first set of slots and the second set of slots). In some cases, the quantity of slots included in a ramp window 325 may increase as the statistical probability of jitter increases, and vice versa. In some examples, the length of the ramp window 325-a and the length of the ramp window 325-b may be the same or different (e.g., the ramp window 325-a and the ramp window 325-b may be separately configured). For example, if there is a greater statistical probability that the transport block 340 arrives early, the length of the ramp window 325-a may be greater than the length of the ramp window 325-b, and vice versa.

The ramp window 325-a may occur before and be adjacent in time to the on-window 330. The ramp window 325-b may occur after and be adjacent in time to the on-window 330. Additionally, the ramp window 325-a may occur after and be adjacent in time to a previous sleep window 335 of a previous DRX cycle, and the ramp window 325-b may occur before and be adjacent in time to the sleep window 335. That is, the ramp window 325-a may be located between the previous sleep window 335 and the on-window 330, and the ramp window 325-b may be located between the on-window 330 and the sleep window 335. Accordingly, if the UE 115 does not receive a transport block 340 during the ramp window 325-a, the UE 115 may transition to the on-window 330 at the end of the ramp window 325-a. If the UE 115 does not receive a transport block 340 during the ramp window 325-b, the UE may transition to the sleep window 335 at the end of the ramp window 325-b.

A configuration for the ramp windows 325 may indicate for a uniform distribution of wakeup slots 315 and sleep slots 320 within the ramp windows 325. For example, the ramp window 325-a and the ramp window 325-b may be configured such that the wakeup slots 315 and the sleep slots 320 within each ramp window 325 are uniformly staggered in time. That is, the wakeup slots 315 of the first subset of wakeup slots 315 may alternate in time with the sleep slots 320 of the first subset of sleep slots 320, and the wakeup slots 315 of the second subset of wakeup slots 315 may alternate in time with the sleep slots 320 of the second subset of sleep slots 320. Accordingly, during the ramp window 325-a and the ramp window 325-b, the UE 115 may transition from an on-state to a sleep state or from the sleep state to the on-state with each subsequent slot according to the staggered slot configuration of the ramp windows 325.

The communication diagram 300 also depicts transition diagrams 310, which may illustrate example operation of the UE 115 in response to receiving a transport block 340 during a ramp window 325. For example, the communication diagram 300 depicts a transition diagram 310-a illustrating operations of the UE 115 in response to receiving a transport block 340-a during the ramp window 325-a. For instance, the UE 115 may monitor for the transport block 340-a during the wakeup slots 315 of the ramp window 325-a. The transport block 340-a may be scheduled to arrive during the on-window 330 but may experience jitter such that the transport block 340-a arrives at the UE 115 during a wakeup slot 315-a of the ramp window 325-a. Based on being in the on-state during the wakeup slot 315-a, the UE 115 may receive and decode the transport block 340-a.

In response to receiving the transport block 340-a, the UE 115 may transition to an on-window 345-a. Here, the UE 115 may remain in the on-state during the on-window 345-a rather than transition back to the sleep state during the remaining sleep slots of the ramp window 325-a. That is, the configuration of the three remaining sleep slots within the ramp window 325-a and after the wakeup slot 315-a may be overridden in response to receiving the transport block 340-a, and the UE 115 may instead remain in the on-state. In some examples, the UE 115 may initiate an inactivity timer 350-a in response to receiving the transport block 340-a. The inactivity timer 350-a may be an example of a DRX-inactivity timer such that expiration of the inactivity timer 350-a may indicate for and cause the UE 115 to transition to the sleep window 335. The UE 115 may be configured to restart (e.g., refresh a duration of) the inactivity timer 350-a for each additional transport block 340 received during the on-window 345-a, thereby extending a duration of the on-window 345-a.

In some examples, the transition to the on-window 345-a and the initiation of the inactivity timer 350-a may override the configuration of the on-window 330 and the configuration of the ramp window 325-b for the DRX cycle. For example, the UE 115 may operate in accordance with the on-window 345-a and the inactivity timer 350-a rather than the on-window 330 and the ramp-window 325-b. Here, the UE 115 may transition to the sleep window 335 upon expiration of the inactivity timer 350-a, for example, rather than transitioning to the ramp window 325-b at the end of the on-window and transitioning to the sleep window 335 at the end of the ramp window 325-b.

In some other examples, transitioning to the on-window 345-a may extend the duration of the on-window 330. For example, transitioning to the on-window 345-a may correspond to transitioning to the on-window 330 earlier than a configured start of the on-window 330. Here, the UE 115 may not initiate the inactivity timer 350-a. Instead, if the UE 115 receives an additional transport block 340 during the extended on-window 330, the UE 115 may initiate an inactivity timer 350 and transition to the sleep window 335 upon expiration of the inactivity timer 350. Otherwise, the UE 115 may transition to the ramp window 325-b at the end of the on-window 330 and transition to the sleep window 335 at the end of the ramp window 325-b if no transport blocks 340 are received during a wakeup slot 315 of the ramp window 325-b.

The communication diagram 300 depicts a transition diagram 310-b illustrating operations of the UE 115 in response to receiving a transport block 340-b during the ramp window 325-b. For example, the UE 115 may monitor for the transport block 340-b during the wakeup slots 315 of the ramp window 325-a. The transport block 340-a may not arrive during the ramp window 325-a, and thus the UE 115 may transition to the on-window 330 at the end of the ramp window 325-a. The transport block 340-b may be scheduled to arrive during the on-window 330 but may experience jitter such that the transport block 340-b arrives after the on-window 330. Accordingly, based on not receiving the transport block 340-b during the on-window 330, the UE 115 may transition to the ramp window 325-b at the end of the on-window 330 and begin to monitor the wakeup slots 315 of the ramp window 325-b. The jitter associated with the transport block 340-b may cause the transport block 340-b to arrive at the UE 115 during a wakeup slot 315-b of the ramp window 325-b. Based on being in the on-state during the wakeup slot 315-b, the UE 115 may receive and decode the transport block 340-b.

In response to receiving the transport block 340-b, the UE 115 may transition to an on-window 345-b. Here, the UE 115 may remain in the on-state during the on-window 345-b rather than transition back to the sleep state during the remaining sleep slots of the ramp window 325-b. That is, the configuration of the three remaining sleep slots within the ramp window 325-b and after the wakeup slot 315-b may be overridden in response to receiving the transport block 340-b, and the UE 115 may instead remain in the on-state. In some examples, the UE 115 may initiate an inactivity timer 350-b in response to receiving the transport block 340-b. The inactivity timer 350-b may be an example of a DRX-inactivity timer such that expiration of the inactivity timer 350-b may indicate for and cause the UE 115 to transition to the sleep window 335. The UE 115 may be configured to restart (e.g., refresh a duration of) the inactivity timer 350-b for each additional transport block 340 received during the on-window 345-b, thereby extending a duration of the on-window 345-b. In some examples, the duration of the on-window 345-b may extend into the sleep window 335, thereby shortening a duration of the sleep window 335. That is, the UE 115 may remain in the on-state for the duration of the on-window 345-b rather than transition to the sleep window 335 at the configured start of the sleep window 335 after the ramp window 325-b if the on-window 345-b extends into the sleep window 335.

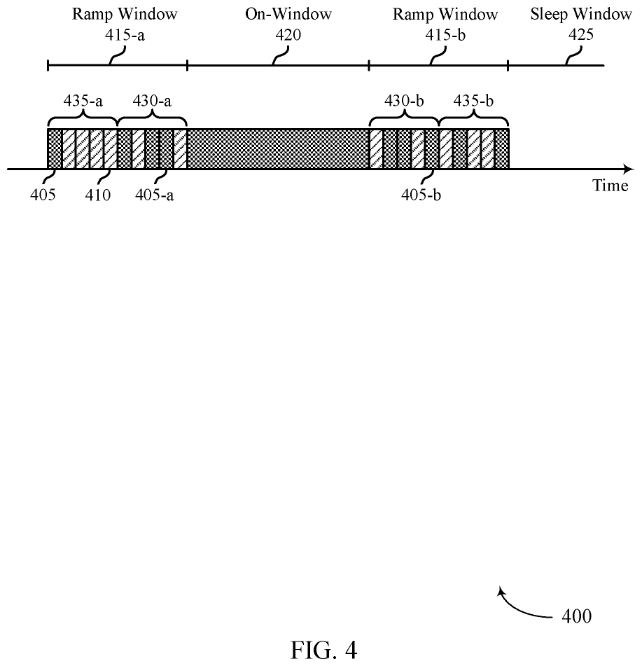

FIG. 4 illustrates an example of a DRX cycle diagram 400 that supports DRX mode communication techniques in accordance with aspects of the present disclosure. The DRX cycle diagram 400 may implement or be implemented by aspects of the wireless communications system 100 and 200 as described with reference to FIGS. 1 and 2, respectively. For example, the DRX cycle diagram 400 may be implemented by a UE 115 and a base station 105 to support ramp window configurations for DRX cycles.

The DRX cycle diagram 400 may depict an example DRX cycle that may be configured at the UE 115 by the base station (e.g., via configuration signaling 210). The DRX cycle may include a ramp window 415-a and a ramp window 415-b, which may be examples of a ramp window 240-a and a ramp window 240-b described with reference to FIG. 2, respectively. The DRX cycle may also include an on-window 420 and a sleep window 425, which may be examples of an on-window 245 and a sleep window 250 described with reference to FIG. 2, respectively.

The ramp window 415-a may include (e.g., span) a first set of slots that includes wakeup slots 405 and sleep slots 410. The ramp window 415-b may include (e.g., span) a second set of slots that includes wakeup slots 405 and sleep slots 410. In the example of FIG. 4, the first set of slots of the ramp window 415-a may include a first subset of wakeup slots 405 that includes four wakeup slots 405 and a first subset of sleep slots 410 that includes six sleep slots 410. The second set of slots of the ramp window 415-b may include a second subset of wakeup slots 405 that includes five wakeup slots 405 and a second subset of sleep slots 410 that includes five sleep slots 410.

In the example of FIG. 4, the ramp window 415-a and the ramp window 415-b may each have a length of ten slots, although such lengths are provided as examples for clarity and ramp windows 415 of any length may be configured and supported. For example, the base station 105 may configure the length of a ramp window 415 (e.g., via configuration signaling 210) based on a statistical probability that a given transport block will experience jitter. In some examples, the length of the ramp window 415-a and the length of the ramp window 415-b may be the same or different.

The ramp window 415-a may occur before and be adjacent in time to the on-window 420, and the ramp window 415-b may occur after and be adjacent in time to the on-window 420. Additionally, the ramp window 415-a may occur after and be adjacent in time to a previous sleep window 425 of a previous DRX cycle, and the ramp window 415-b may occur before and be adjacent in time to the sleep window 425. That is, the ramp window 415-a may be located between the previous sleep window 425 and the on-window 420, and the ramp window 415-b may be located between the on-window 420 and the sleep window 425. Accordingly, if the UE 115 does not receive a transport block during the ramp window 415-a, the UE 115 may transition to the on-window 420 at the end of the ramp window 415-a. If the UE 115 does not receive a transport block during the ramp window 415-b, the UE may transition to the sleep window 425 at the end of the ramp window 415-b.

A configuration for the ramp windows 415 may be based on statistical probabilities of arrival times of jittered transport blocks. For example, a jittered transport block may have a greater probability of arriving in a slot that is closer to an edge of the on-window 420 in time than a slot that is farther from the edge of the on-window 420 in time. Accordingly, a duration of a ramp window 415 that is relatively close to the edge of the on-window 420 may include a greater quantity of wakeup slots 405 than sleep slots 410, while a duration of the ramp window 415 that is relatively farther from the edge of the on-window 420 may include a greater quantity of sleep slots 410 than wakeup slots 405. For example, the ramp window 415-a may include a duration 435-a and a duration 430-a that each span a respective subset of slots the first set of slots. The duration 430-a may be closer to the on-window 420 than the duration 435-a. Accordingly, the ramp window 415-a may be configured such that the duration 430-a includes a greater quantity of wakeup slots 405 than sleep slots 410 (e.g., three wakeup slots 405 and two sleep slots 410) and the duration 435-a includes a greater quantity of sleep slots 410 than wakeup slots 405 (e.g., four sleep slots 410 and one wakeup slot 405). In some examples, the duration 430-a may include a greater quantity of sleep slots 410 than wakeup slots 405 or the duration 435-a may include a greater quantity of wakeup slots 405 than sleep slots 410, but a ratio of wakeup slots 405 to sleep slots 410 included in the duration 430-a may be greater than a ratio of wakeup slots 405 to sleep slots 410 included in the duration 435-a. That is, the duration 430-a may include a first ratio of wakeup slots 405 to sleep slots 410, and the duration 435-a may include a second ratio of wakeup slots 405 to sleep slots 410 that is less than the first ratio.

Additionally or alternatively, the ramp window 415-b may include a duration 435-b and a duration 430-b that each span a respective subset of slots the second set of slots. The duration 430-b may be closer to the on-window 420 than the duration 435-b. Accordingly, the ramp window 415-b may be configured such that a first ratio of wakeup slots 405 to sleep slots 410 of the duration 430-b is greater than a second ratio of wakeup slots 405 to sleep slots 410 of the duration 435-a.

In some examples, the UE 115 may receive a transport block during a ramp window 415-a. For example, the UE 115 may monitor for the transport block during the wakeup slots 405 of the ramp window 415-a. The transport block may arrive at the UE 115 during a wakeup slot 405-a, and the UE 115 may receive and decode the transport block based on being in the on-state during the wakeup slot 405-a. In response to receiving the transport block during the wakeup slot 405-a, the UE 115 may transition to an on-window 345-a described with reference to FIG. 3 and operate in accordance with the on-window 345-a (e.g., and the inactivity timer 350-a). Alternatively, the transport block may arrive at the UE 115 during a wakeup slot 405-b of the ramp window 415-b. Here, the UE 115 may transition from the ramp window 415-a to the on-window 420 and from the on-window 420 to the ramp window 415-b based on the transport block arriving after the on-window 420. The UE 115 may monitor for the transport block during the wakeup slots 405 of the ramp window 415-b and may receive and decode the transport block based on being in the on-state during the wakeup slot 405-b. In response to receiving the transport block during the wakeup slot 405-b, the UE 115 may transition to an on-window 345-b described with reference to FIG. 3 and operate in accordance with the on-window 345-b (e.g., and the inactivity timer 350-b).

FIG. 5 illustrates an example of a DRX cycle diagram 500 that supports DRX mode communication techniques in accordance with aspects of the present disclosure. The DRX cycle diagram 500 may implement or be implemented by aspects of the wireless communications system 100 and 200 as described with reference to FIGS. 1 and 2, respectively. For example, the DRX cycle diagram 500 may be implemented by a UE 115 and a base station 105 to support ramp window configurations for DRX cycles.

The DRX cycle diagram 500 may depict an example DRX cycle that may be configured at the UE 115 by the base station (e.g., via configuration signaling 210). The DRX cycle may include a ramp window 515-a and a ramp window 515-b, which may be examples of a ramp window 240-a and a ramp window 240-b described with reference to FIG. 2, respectively. The DRX cycle may also include an on-window 520 and a sleep window 525, which may be examples of an on-window 245 and a sleep window 250 described with reference to FIG. 2, respectively.

The ramp window 515-a may include (e.g., span) a first set of slots that includes wakeup slots 505 and sleep slots 510. The ramp window 515-b may include (e.g., span) a second set of slots that includes wakeup slots 505 and sleep slots 510. In the example of FIG. 5, the first set of slots of the ramp window 515-a may include a first subset of wakeup slots 505 that includes five wakeup slots 505 and a first subset of sleep slots 510 that includes five sleep slots 510. The second set of slots of the ramp window 515-b may include a second subset of wakeup slots 505 that includes five wakeup slots 505 and a second subset of sleep slots 510 that includes five sleep slots 510.

In the example of FIG. 5, the ramp window 515-a and the ramp window 515-b may each have a length of ten slots, although such lengths are provided as examples for clarity and ramp windows 515 of any length may be configured and supported. For example, the base station 105 may configure the length of a ramp window 515 (e.g., via configuration signaling 210) based on a statistical probability that a given transport block will experience jitter. In some examples, the length of the ramp window 515-a and the length of the ramp window 515-b may be the same or different.

The ramp window 515-a may occur before and be adjacent in time to the on-window 520, and the ramp window 515-b may occur after and be adjacent in time to the on-window 520. Additionally, the ramp window 515-a may occur after and be adjacent in time to a previous sleep window 525 of a previous DRX cycle, and the ramp window 515-b may occur before and be adjacent in time to the sleep window 525. That is, the ramp window 515-a may be located between the previous sleep window 525 and the on-window 520, and the ramp window 515-b may be located between the on-window 520 and the sleep window 525. Accordingly, if the UE 115 does not receive a transport block during the ramp window 515-a, the UE 115 may transition to the on-window 520 at the end of the ramp window 515-a. If the UE 115 does not receive a transport block during the ramp window 515-b, the UE may transition to the sleep window 525 at the end of the ramp window 515-b.

A configuration for the ramp windows 515 may be based on a jitter experienced by one or more uplink messages transmitted by the UE 115 to the base station (e.g., a jitter of uplink messages 225 described with reference to FIG. 2). For example, there may be channel reciprocity between an uplink channel over which the UE 115 transmits uplink messages to the base station 105 and a downlink channel over which the base station 105 transmits downlink messages to the UE 115. That is, channel characteristics of the uplink channel may be similar to or the same as channel characteristics of the downlink channel. Accordingly, a jitter and latency associated with uplink messages may be similar to or the same as jitter and latency associated with downlink messages that are communicated within a relatively short period of time of each other (e.g., within a time period that the characteristics of the uplink channel and the downlink channel are relatively unchanged). Therefore, the base station 105 may receive one or more uplink messages from the UE 115 and determine a jitter of the one or more uplink messages to determine or predict a jitter of a downlink message (e.g., a transport block) transmitted relatively soon after reception of the one or more uplink messages. In some examples, the base station 105 may determine the jitter by measuring a difference between the actual arrival time of the one or more uplink messages and the scheduled arrival time of the one or more uplink messages. In some examples, a time stamp may be used to determine the jitter. For example, an uplink message may be marked with a first time stamp to indicate the transmission time of the uplink message by the UE 115 and may be marked with a second time stamp to indicate the reception time of the uplink message by the base station 105. The base station 105 may measure the difference between the first time stamp and the second time stamp to determine the latency and jitter of the uplink message.

The base station 105 may indicate (e.g., configure) locations of the wakeup slots 505 and locations of the sleep slots 510 within the ramp windows 515 based on the jitter a transport block that is predicted based on the determined jitter of the one or more uplink messages. For example, based on the predicted jitter of the transport block, the configuration for the ramp window 515-a may indicate a location of a slot group 530-a and a location of a slot group 535-a, and the configuration for the ramp window 515-b may indicate a location of a slot group 530-b and a location of a slot group 535-b. The slot groups 530-a and 530-b may include a greater quantity of wakeup slots 505 than sleep slots 510 based on the predicted jitter, and the slot groups 535-a and 535-b may include a greater quantity of sleep slots 510 than wakeup slots 505 based on the predicted jitter. For example, the locations of the slot groups 530 may correspond to (e.g., span) slots during which there is a higher probability that a jittered transport block arrives based on the predicted jitter. The locations of the slot groups 535 may correspond to (e.g., span) slots during which there is a lower probability that a jittered transport block arrives based on the predicted jitter.

In some examples, the slot group 530-a, the slot group 530-b, or both, may be groups of consecutive wakeup slots 505 with sleep slots 510 excluded from the slot groups 530. In some examples, the slot groups 535-a, the slot groups 535-b, or both, may be groups of consecutive sleep slots 510 with wakeup slots 505 excluded from the slot groups 535. In some cases, the slot groups 530 may be referred to as dense wakeup slot groups, and the slot groups 535 may be referred to as dense sleep slot groups. In some examples, a slot group 530 and a slot group 535 may together span the duration of a ramp window 515. In some examples, a slot group 530 and a slot group 535 may together span a portion of the duration of a ramp window 515. In some cases, remaining portions of the ramp window 515 outside of the portion spanned by the slot group 530 and the slot group 535 may include staggered wakeup slots 505 and sleep slots 510.

In some examples, the configurations for the ramp windows 515 may indicate the locations of the slot groups 530 and the slot groups 535 using respective offsets 540. For example, the base station 105 may indicate an offset 540-a (e.g., in slots) from the on-window 520 at which the slot group 530-a starts, an offset 540-b (e.g., in slots) from the on-window 520 at which the slot group 535-a starts, an offset 540-c (e.g., in slots) from the on-window 520 at which the slot group 530-b starts, an offset 540-d (e.g., in slots) from the on-window 520 at which the slot group 535-b starts. In some cases, the offsets 540 may indicate an offset in slots from the on-window at which a respective slot group 530 or a respective slot group 535 ends.

In some examples, the UE 115 may receive a transport block during a ramp window 515-a. For example, the UE 115 may monitor for the transport block during the wakeup slots 505 of the ramp window 515-a. The transport block may arrive at the UE 115 during a wakeup slot 505-a, and the UE 115 may receive and decode the transport block based on being in the on-state during the wakeup slot 505-a. In response to receiving the transport block during the wakeup slot 505-a, the UE 115 may transition to an on-window 345-a described with reference to FIG. 3 and operate in accordance with the on-window 345-a (e.g., and the inactivity timer 350-a). Alternatively, the transport block may arrive at the UE 115 during a wakeup slot 505-b of the ramp window 515-b. Here, the UE 115 may transition from the ramp window 515-a to the on-window 520 and from the on-window 520 to the ramp window 515-b based on the transport block arriving after the on-window 520. The UE 115 may monitor for the transport block during the wakeup slots 505 of the ramp window 515-b and may receive and decode the transport block based on being in the on-state during the wakeup slot 505-b. In response to receiving the transport block during the wakeup slot 505-b, the UE 115 may transition to an on-window 345-b described with reference to FIG. 3 and operate in accordance with the on-window 345-b (e.g., and the inactivity timer 350-b).

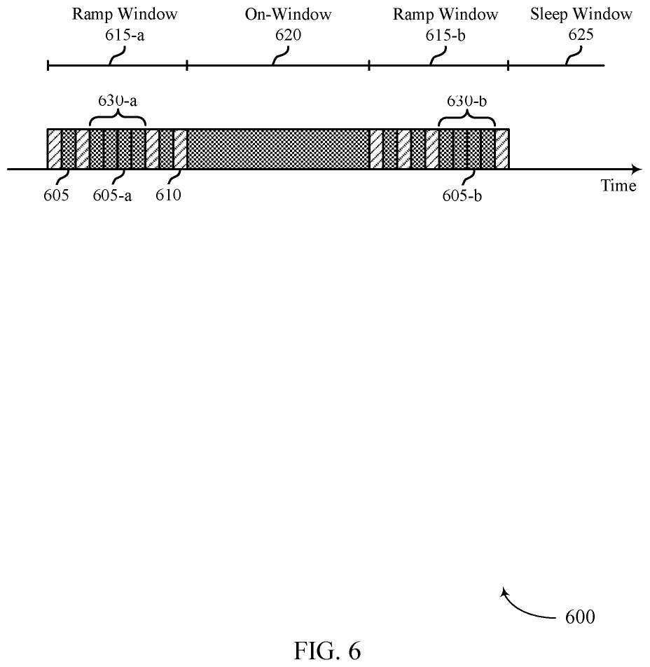

FIG. 6 illustrates an example of a DRX cycle diagram 600 that supports DRX mode communication techniques in accordance with aspects of the present disclosure. The DRX cycle diagram 600 may implement or be implemented by aspects of the wireless communications system 100 and 200 as described with reference to FIGS. 1 and 2, respectively. For example, the DRX cycle diagram 600 may be implemented by a UE 115 and a base station 105 to support ramp window configurations for DRX cycles.

The DRX cycle diagram 600 may depict an example DRX cycle that may be configured at the UE 115 by the base station (e.g., via configuration signaling 210). The DRX cycle may include a ramp window 615-a and a ramp window 615-b, which may be examples of a ramp window 240-a and a ramp window 240-b described with reference to FIG. 2, respectively. The DRX cycle may also include an on-window 620 and a sleep window 625, which may be examples of an on-window 245 and a sleep window 250 described with reference to FIG. 2, respectively.

The ramp window 615-a may include (e.g., span) a first set of slots that includes wakeup slots 605 and sleep slots 610. The ramp window 615-b may include (e.g., span) a second set of slots that includes wakeup slots 605 and sleep slots 610. In the example of FIG. 6, the first set of slots of the ramp window 615-a may include a first subset of wakeup slots 605 that includes six wakeup slots 605 and a first subset of sleep slots 610 that includes four sleep slots 610. The second set of slots of the ramp window 615-b may include a second subset of wakeup slots 605 that includes six wakeup slots 605 and a second subset of sleep slots 610 that includes four sleep slots 610.

In the example of FIG. 6, the ramp window 615-a and the ramp window 615-b may each have a length of ten slots, although such lengths are provided as examples for clarity and ramp windows 615 of any length may be configured and supported. For example, the base station 105 may configure the length of a ramp window 615 (e.g., via configuration signaling 210) based on a statistical probability that a given transport block will experience jitter. In some examples, the length of the ramp window 615-a and the length of the ramp window 615-b may be the same or different.

The ramp window 615-a may occur before and be adjacent in time to the on-window 620, and the ramp window 615-b may occur after and be adjacent in time to the on-window 620. Additionally, the ramp window 615-a may occur after and be adjacent in time to a previous sleep window 625 of a previous DRX cycle, and the ramp window 615-b may occur before and be adjacent in time to the sleep window 625. That is, the ramp window 615-a may be located between the previous sleep window 625 and the on-window 620, and the ramp window 615-b may be located between the on-window 620 and the sleep window 625. Accordingly, if the UE 115 does not receive a transport block during the ramp window 615-a, the UE 115 may transition to the on-window 620 at the end of the ramp window 615-a. If the UE 115 does not receive a transport block during the ramp window 615-b, the UE may transition to the sleep window 625 at the end of the ramp window 615-b.

A configuration for a ramp window 615 may indicate a location of a slot group 630 that includes a greater quantity of wakeup slots 605 than sleep slots 610. The configuration for the ramp windows 615 may also indicate a quantity of slots included in the slot group 630, a quantity of wakeup slots 605 included in the slot group 630, a quantity of sleep slots included in the slot group 630, or a combination thereof. The configuration for the ramp windows 615 may also indicate that remaining slots of a ramp window excluded from the slot group 630 may include staggered wakeup slots 605 and sleep slots 610. For example, the base station 105 may indicate a configuration for (e.g., a location of, slots included in) a slot group 630-a within the ramp window 615-a and a configuration for (e.g., a location of, slots included in) a slot group 630-b within the ramp window 615-b.

The configurations for the slot group 630-a and the slot group 630-b may be based on predicted jitter of a transport block transmitted to the UE 115. For example, the base station 105 may predict a jitter of the transport block, for instance, based on determined (e.g., estimated) uplink jitter or an increased probability that a jittered transport block will arrive closer to an edge of the on-window 620. Based on the predicted jitter, the base station 105 may indicate the location of the slot group 630-a and the location of the slot group 630-b and may indicate that remaining wakeup slots 605 and sleep slots 610 of the ramp windows 615 are staggered in time.

In some examples, the slot group 630-a, the slot group 630-b, or both, may be groups of consecutive wakeup slots 605 with sleep slots 610 excluded from the slot groups 630. Here, the configurations for the slot groups 630 may indicate the respective locations of the slot groups 630 (e.g., via an offset 540 described with reference to FIG. 5) and respective quantities of consecutive wakeup slots 605 included in the slot groups 630. Accordingly, the UE 115 may remain in the on-state for a duration of the slot group 630-a, a duration of the slot group 630-b, or both.

In some examples, the UE 115 may receive a transport block during a ramp window 615-a. For example, the UE 115 may monitor for the transport block during the wakeup slots 605 of the ramp window 615-a. The transport block may arrive at the UE 115 during a wakeup slot 605-a, and the UE 115 may receive and decode the transport block based on being in the on-state during the wakeup slot 605-a. In response to receiving the transport block during the wakeup slot 605-a, the UE 115 may transition to an on-window 345-a described with reference to FIG. 3 and operate in accordance with the on-window 345-a (e.g., and the inactivity timer 350-a). Alternatively, the transport block may arrive at the UE 115 during a wakeup slot 605-b of the ramp window 615-b. Here, the UE 115 may transition from the ramp window 615-a to the on-window 620 and from the on-window 620 to the ramp window 615-b based on the transport block arriving after the on-window 620. The UE 115 may monitor for the transport block during the wakeup slots 605 of the ramp window 615-b and may receive and decode the transport block based on being in the on-state during the wakeup slot 605-b. In response to receiving the transport block during the wakeup slot 605-b, the UE 115 may transition to an on-window 345-b described with reference to FIG. 3 and operate in accordance with the on-window 345-b (e.g., and the inactivity timer 350-b).

FIG. 7 illustrates an example of a DRX cycle diagram 700 that supports DRX mode communication techniques in accordance with aspects of the present disclosure. The DRX cycle diagram 700 may implement or be implemented by aspects of the wireless communications system 100 and 200 as described with reference to FIGS. 1 and 2, respectively. For example, the DRX cycle diagram 700 may be implemented by a UE 115 and a base station 105 to support ramp window configurations for DRX cycles.

The DRX cycle diagram 700 may depict an example DRX cycle 715 that may be configured at the UE 115 by the base station (e.g., via configuration signaling 210). The DRX cycle 715 may include one or more ramp windows, which may be examples of ramp windows 240 described with reference to FIG. 2, respectively. The DRX cycle 715 may also include a sleep window 730, which may be an example of a sleep window 250 described with reference to FIG. 2, respectively.

In some examples, the DRX cycle 715 may be configured with a single ramp window 720. Here, the ramp window 720 may occur before and be adjacent in time to the sleep window 730. In some cases, the ramp window 720 may also occur after and be adjacent in time to a previous sleep window 730 of a previous DRX cycle 715. Accordingly, if the UE 115 does not receive a transport block during the ramp window 720, the UE 115 may transition to the sleep window 730 at the end of the ramp window 720.

In some examples, the DRX cycle 715 may be configured with two ramp windows 735 that are consecutive in time. For example, the DRX cycle 715 may be configured with a ramp window 735-a and a ramp window 735-b that are consecutive in time, as depicted in a ramp window diagram 740. Here, the ramp window 735-a may occur before and be adjacent in time to the ramp window 735-b, and the ramp window 735-b may occur and be adjacent in time to the sleep window 730. In some cases, the ramp window 735-a may occur after and be adjacent in time with the previous sleep window 730 of the previous DRX cycle 715. Thus, if the UE 115 does not receive a transport block during the ramp window 735-a, the UE 115 may transition to the ramp window 735-b at the end of the ramp window 735-a, and if the UE 115 does not receive a transport block during the ramp window 735-b, the UE may transition to the sleep window 730 at the end of the ramp window 735-b.

In the example of FIG. 7, the one or more ramp windows may correspond to or replace an on-window 725 of the DRX cycle 715. That is, instead of being configured with an on-window 725 in which the UE 115 is in the on-state for the entire duration of the on-window 725, the DRX cycle 715 may be configured with the one or more ramp windows during which the UE 115 may receive and decode transport blocks from the base station 105. In this way, power consumption associated with the DRX cycle 715 may be reduced as the one or more ramp windows may include sleep slots 710 during which the UE 115 is in a sleep state.

The ramp window 720 may include (e.g., span) a set of slots that includes wakeup slots 705 and sleep slots 710. In the example of FIG. 7, the set of slots of the ramp window 720 may include a first subset of wakeup slots 705 that includes five wakeup slots 705 and a first subset of sleep slots 710 that includes five sleep slots 710. Alternatively, the ramp window 735-a may include (e.g., span) a first set of slots that includes wakeup slots 705 and sleep slots 710, and the ramp window 735-b may include a second set of slots that includes wakeup slots 705 and sleep slots 710. In the example of FIG. 7, the first set of slots of the ramp window 735-a may include a first subset of wakeup slots 705 that includes two wakeup slots 705 and a first subset of sleep slots 710 that includes three sleep slots 710. The second set of slots of the ramp window 735-b may include a second subset of wakeup subset of wakeup slots 705 that includes three wakeup slots 705 and a second subset of sleep slots 710 that includes two sleep slots 710.

In the example of FIG. 7, the ramp window 720 may have a length of ten slots, and the ramp window 735-a and the ramp window 735-b may each have a length of five slots, although such lengths are provided as examples for clarity and ramp windows of any length may be configured and supported.

A configuration for the ramp windows may indicate for a uniform distribution of wakeup slots and 705 and sleep slots 710 within the ramp windows. For example, the ramp windows may be configured such that the wakeup slots 705 and the sleep slots 710 are uniformly staggered (e.g., alternating) in time. If the two ramp windows 735 are configured, the staggering of the wakeup slots 705 and the sleep slots 710 may be such that the staggering is maintained when transitioning from the ramp window 735-a to the ramp window 735-b.

In some examples, the UE 115 may receive a transport block during a ramp window 720 or one of the ramp windows 735. For example, the UE 115 may monitor for the transport block during the wakeup slots 705 of the ramp window(s). The transport block may arrive at the UE 115 during a wakeup slot 705-a, and the UE 115 may receive and decode the transport block based on being in the on-state during the wakeup slot 705-a. In response to receiving the transport block during the wakeup slot 705-a, the UE 115 may transition to an on-window 345-a and initiate an inactivity timer 350-a described with reference to FIG. 3 and operate in accordance with the on-window 345-a and the inactivity timer 350-a).

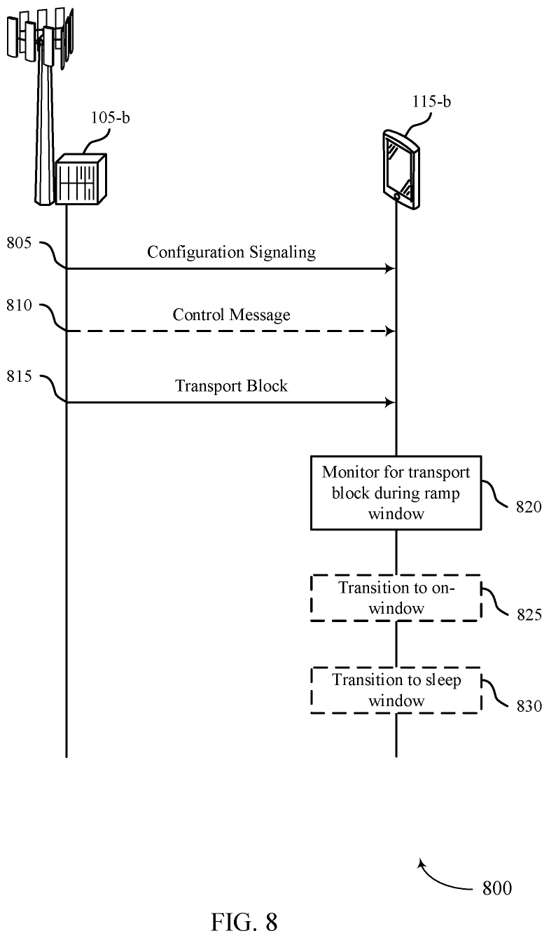

FIG. 8 illustrates an example of a process flow 800 that supports DRX mode communication techniques in accordance with aspects of the present disclosure. The process flow 800 may implement or be implemented by aspects of a wireless communications system 100 and 200 as described with reference to FIGS. 1 and 2. For example, the process flow 800 may be implemented by a base station 105-b and a UE 115-b to support the ramp window configurations for DRX cycles.

The base station 105-b and the UE 115-b may be examples of a base station 105 or a UE 115, as described with reference to FIGS. 1 through 7. In the following description of the process flow 800, the operations between the base station 105-b and the UE 115-b may be communicated in a different order than the example order shown, or the operations performed by the base station 105-b and the UE 115-b may be performed in different orders or at different times. Some operations may also be omitted from the process flow 800, and other operations may be added to the process flow 800. Further, although some operations or signaling may be shown to occur at different times for discussion purposes, these operations may actually occur at the same time.

At 805, the base station 105-b may transmit configuration signaling to the UE 115-b that indicates a configuration for one or more ramp windows of a DRX cycle of the UE 115-b. For example, the configuration signaling may indicate a quantity of ramp windows in the DRX cycle, a length of the one or more ramp windows (e.g., a quantity of slots included in the one or more ramp windows), a quantity of wakeup slots in the one or more ramp windows, a quantity of sleep slots in the one or more ramp windows, locations of the wakeup slots within the one or more ramp windows, locations of the sleep slots within the one or more windows, or a combination thereof.

In some examples, the configuration signaling may also indicate a duration (e.g., length) of the DRX cycle and a location and duration of a sleep window of the DRX cycle. In some cases, the configuration signaling may indicate a location and duration of an on-window of the DRX cycle or may indicate that the one or more ramp windows correspond to (e.g., replace) the on-window of the DRX cycle. The one or more ramp windows may be outside of (e.g., adjacent to) the sleep window, the on-window, or both. In some examples, the UE 115-b may receive the configuration signaling via RRC signaling.

At 810, the base station 105-b may transmit a control message that activates monitoring of transport blocks in accordance with the one or more ramp windows. For example, the base station 105-b may transmit a MAC-CE or DCI to the UE 115-b that activates the configuration for the one or more ramp windows.

At 815, the base station 105-b may transmit a transport block to the UE 115-b. In some examples, the transport block may experience jitter such that the transport block arrives at the UE 115-b during one or the one or more ramp windows (e.g., rather than during the on-window).

At 820, the UE 115-b may monitor for the transport block during the one or more ramp windows. For example, the UE 115-b may be in an on-state during wakeup slots of the one or more ramp windows and may monitor for the transport block while in the on-state.

At 825, the UE 115-b may transition to the on-window of the DRX cycle in response to receiving the transport during a wakeup slot of the one or more ramp windows. For example, if the transport block arrives at the UE 115-b during the wakeup slot, the UE 115-b may receive and decode the transport block. In response, the UE 115-b may transition to the on-window and may initiate a DRX-inactivity timer.

At 830, the UE 115-b may transition to the sleep window of the DRX cycle in response to not receiving the transport block during the one or more ramp windows (e.g., or during the on-window). For example, if the transport block arrives at the UE 115-b during a sleep slot of the one or more ramp windows, the UE 115-b may miss reception of the transport block. Accordingly, the UE 115-b may not transition to the on-window or initiate the DRX-inactivity timer and may instead transition to the sleep window at a configured start of the sleep window (e.g., after the one or more ramp windows).

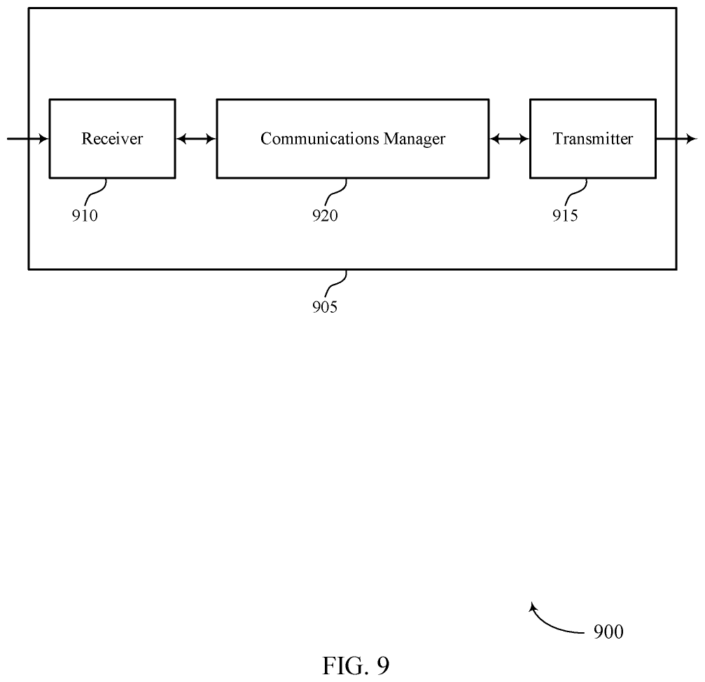

FIG. 9 shows a block diagram 900 of a device 905 that supports DRX mode communication techniques in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to DRX mode communication techniques). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to DRX mode communication techniques). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of DRX mode communication techniques as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a UE in accordance with examples as disclosed herein. For example, the communications manager 920 may be configured as or otherwise support a means for receiving, from a base station, signaling that indicates a configuration of a ramp window that is associated with a DRX cycle of the UE, the ramp window including a set of slots adjacent to a sleep window of the DRX cycle, where the set of slots includes a first subset of wakeup slots during which the UE is in an on-state and a second subset of sleep slots during which the UE is in a sleep state. The communications manager 920 may be configured as or otherwise support a means for monitoring for a transport block from the base station during the first subset of wakeup slots in accordance with the configuration of the ramp window.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced processing and reduced power consumption, for example, by enabling reception of transport blocks during a ramp window of a DRX cycle.

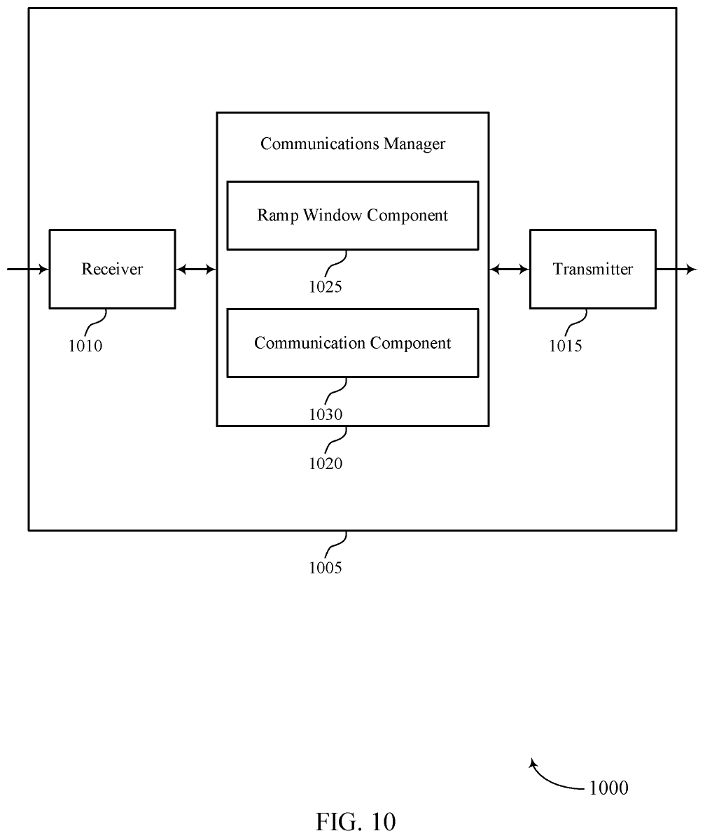

FIG. 10 shows a block diagram 1000 of a device 1005 that supports DRX mode communication techniques in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to DRX mode communication techniques). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to DRX mode communication techniques). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of DRX mode communication techniques as described herein. For example, the communications manager 1020 may include a ramp window component 1025 a communication component 1030, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a UE in accordance with examples as disclosed herein. The ramp window component 1025 may be configured as or otherwise support a means for receiving, from a base station, signaling that indicates a configuration of a ramp window that is associated with a DRX cycle of the UE, the ramp window including a set of slots adjacent to a sleep window of the DRX cycle, where the set of slots includes a first subset of wakeup slots during which the UE is in an on-state and a second subset of sleep slots during which the UE is in a sleep state. The communication component 1030 may be configured as or otherwise support a means for monitoring for a transport block from the base station during the first subset of wakeup slots in accordance with the configuration of the ramp window.

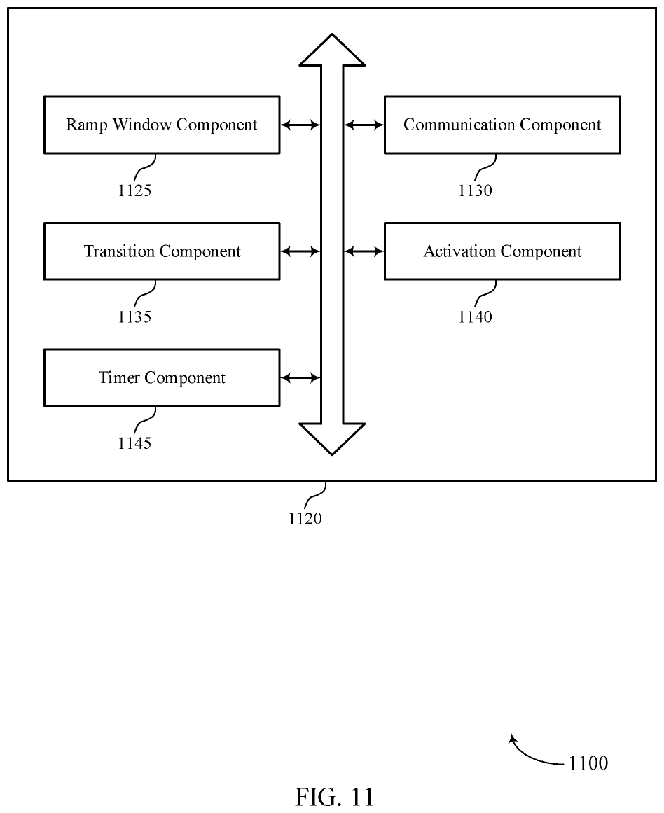

FIG. 11 shows a block diagram 1100 of a communications manager 1120 that supports DRX mode communication techniques in accordance with aspects of the present disclosure. The communications manager 1120 may be an example of aspects of a communications manager 920, a communications manager 1020, or both, as described herein. The communications manager 1120, or various components thereof, may be an example of means for performing various aspects of DRX mode communication techniques as described herein. For example, the communications manager 1120 may include a ramp window component 1125, a communication component 1130, a transition component 1135, an activation component 1140, a timer component 1145, or any combination thereof. Each of these components may communicate, directly or indirectly, with one another (e.g., via one or more buses).

The communications manager 1120 may support wireless communication at a UE in accordance with examples as disclosed herein. The ramp window component 1125 may be configured as or otherwise support a means for receiving, from a base station, signaling that indicates a configuration of a ramp window that is associated with a DRX cycle of the UE, the ramp window including a set of slots adjacent to a sleep window of the DRX cycle, where the set of slots includes a first subset of wakeup slots during which the UE is in an on-state and a second subset of sleep slots during which the UE is in a sleep state. The communication component 1130 may be configured as or otherwise support a means for monitoring for a transport block from the base station during the first subset of wakeup slots in accordance with the configuration of the ramp window.

In some examples, the communication component 1130 may be configured as or otherwise support a means for receiving the transport block during a wakeup slot of the first subset of wakeup slots based on the monitoring. In some examples, the transition component 1135 may be configured as or otherwise support a means for transitioning to an on-window of the DRX cycle based on receiving the transport block during the wakeup slot.

In some examples, the timer component 1145 may be configured as or otherwise support a means for initiating an inactivity timer associated with the DRX cycle in response to receiving the transport block during the wakeup slot, where an expiration of the inactivity timer indicates for the UE to transition to the sleep window.

In some examples, the set of slots may occur before an on-window of the DRX cycle, and the transition component 1135 may be configured as or otherwise support a means for transitioning to the on-window of the DRX cycle based on failing to receive the transport block during the first subset of wakeup slots.

In some examples, the set of slots may occur after an on-window of the DRX cycle, and the transition component 1135 may be configured as or otherwise support a means for transitioning to the sleep window of the DRX cycle based on failing to receive the transport block during the first subset of wakeup slots.

In some examples, the activation component 1140 may be configured as or otherwise support a means for receiving, from the base station, a control message that activates the monitoring of the transport block in accordance with the configuration of the ramp window.

In some examples, wakeup slots of the first subset of wakeup slots alternate with sleep slots of the second subset of sleep slots in time.

In some examples, the ramp window includes a first duration and a second duration, the first duration closer in time to an on-window of the DRX cycle than the second duration. In some examples, the first duration includes a first quantity of wakeup slots of the first subset of wakeup slots that is greater than a second quantity of wakeup slots of the first subset of wakeup slots included in the second duration based on the first duration being closer in time to the on-window of the DRX cycle.

In some examples, a location of the first subset of wakeup slots within the ramp window and a location of the second subset of sleep slots within the ramp window are based on a jitter of an uplink message transmitted by the UE, the jitter of the uplink message corresponding to a difference between an arrival time of the uplink message and a scheduled reception time of the uplink message.

In some examples, the configuration for the ramp window indicates a location of a first group of slots of the set of slots including a greater quantity of wakeup slots than sleep slots based on the jitter of the uplink message. In some examples, the configuration for the ramp window indicates a location of a second group of slots of the set of slots including a greater quantity of sleep slots than wakeup slots based on the jitter of the uplink message.

In some examples, the configuration for the ramp window indicates a location of a first group of slots of the set of slots including a greater quantity of wakeup slots than sleep slots. In some examples, wakeup slots of the first subset of wakeup slots and excluded from the first group of slots alternate in time with sleep slots of the second subset of sleep slots and excluded from the first group of slots.

In some examples, the signaling indicates a second configuration of a second ramp window associated with the DRX cycle, the second ramp window including a second set of slots outside the sleep window of the DRX cycle. In some examples, the second set of slots includes a third subset of wakeup slots and a fourth subset of sleep slots.

In some examples, the ramp window and the second ramp window are consecutive in time. In some examples, an on-window of the DRX cycle corresponds to the ramp window and the second ramp window.

In some examples, an on-window of the DRX cycle corresponds to the ramp window including the first subset of wakeup slots and the second subset of sleep slots.

In some examples, the set of slots is adjacent to an on-window of the DRX cycle.

In some examples, a quantity of slots included in the set of slots is based on a statistical probability that a downlink message scheduled for reception during an on-window of the DRX cycle is received outside of the on-window.

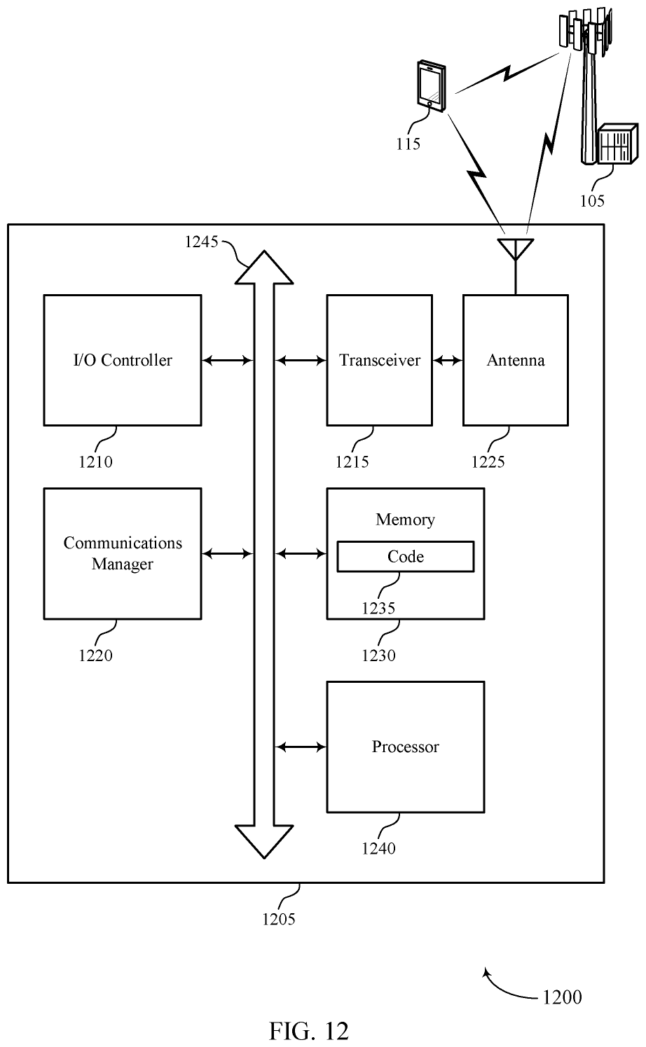

FIG. 12 shows a diagram of a system 1200 including a device 1205 that supports DRX mode communication techniques in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting DRX mode communication techniques). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at a UE in accordance with examples as disclosed herein. For example, the communications manager 1220 may be configured as or otherwise support a means for receiving, from a base station, signaling that indicates a configuration of a ramp window that is associated with a DRX cycle of the UE, the ramp window including a set of slots adjacent to a sleep window of the DRX cycle, where the set of slots includes a first subset of wakeup slots during which the UE is in an on-state and a second subset of sleep slots during which the UE is in a sleep state. The communications manager 1220 may be configured as or otherwise support a means for monitoring for a transport block from the base station during the first subset of wakeup slots in accordance with the configuration of the ramp window.

By including or configuring the communications manager 1220 in accordance with examples as described herein, the device 1205 may support techniques for reduced power consumption, reduced latency, increased reliability, increased data rates, more efficient utilization of communication resources, improved coordination between devices, and longer battery life, among other benefits.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of DRX mode communication techniques as described herein, or the processor 1240 and the memory 1230 may be otherwise configured to perform or support such operations.

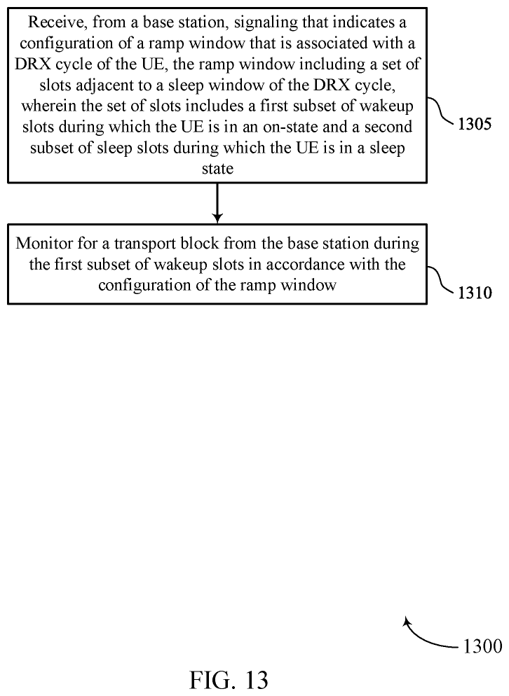

FIG. 13 shows a flowchart illustrating a method 1300 that supports DRX mode communication techniques in accordance with aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, signaling that indicates a configuration of a ramp window that is associated with a DRX cycle of the UE, the ramp window including a set of slots adjacent to a sleep window of the DRX cycle, where the set of slots includes a first subset of wakeup slots during which the UE is in an on-state and a second subset of sleep slots during which the UE is in a sleep state. The operations of 1305 may be performed in accordance with examples as disclosed herein. In some examples, aspects of the operations of 1305 may be performed by a ramp window component 1125 as described with reference to FIG. 11.

At 1310, the method may include monitoring for a transport block from the base station during the first subset of wakeup slots in accordance with the configuration of the ramp window. The operations of 1310 may be performed in accordance with examples as disclosed herein. In some examples, aspects of the operations of 1310 may be performed by a communication component 1130 as described with reference to FIG. 11.

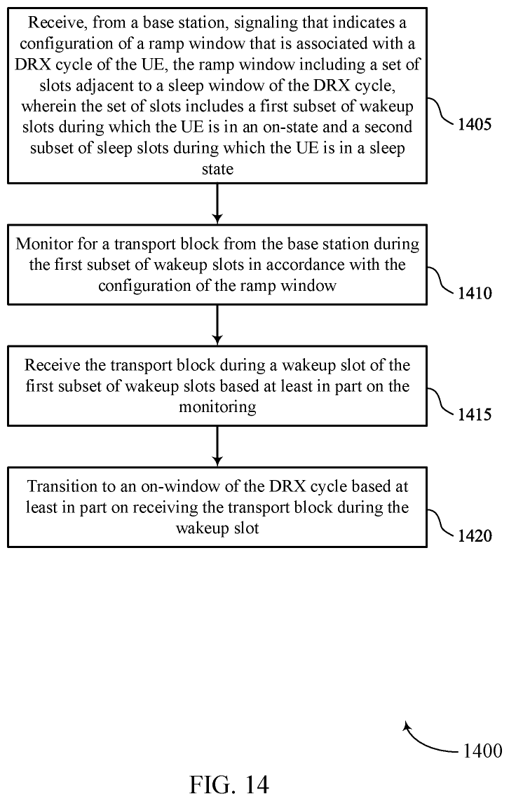

FIG. 14 shows a flowchart illustrating a method 1400 that supports DRX mode communication techniques in accordance with aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, signaling that indicates a configuration of a ramp window that is associated with a DRX cycle of the UE, the ramp window including a set of slots adjacent to a sleep window of the DRX cycle, where the set of slots includes a first subset of wakeup slots during which the UE is in an on-state and a second subset of sleep slots during which the UE is in a sleep state. The operations of 1405 may be performed in accordance with examples as disclosed herein. In some examples, aspects of the operations of 1405 may be performed by a ramp window component 1125 as described with reference to FIG. 11.

At 1410, the method may include monitoring for a transport block from the base station during the first subset of wakeup slots in accordance with the configuration of the ramp window. The operations of 1410 may be performed in accordance with examples as disclosed herein. In some examples, aspects of the operations of 1410 may be performed by a communication component 1130 as described with reference to FIG. 11.

At 1415, the method may include receiving the transport block during a wakeup slot of the first subset of wakeup slots based on the monitoring. The operations of 1415 may be performed in accordance with examples as disclosed herein. In some examples, aspects of the operations of 1415 may be performed by a communication component 1130 as described with reference to FIG. 11.

At 1420, the method may include transitioning to an on-window of the DRX cycle based on receiving the transport block during the wakeup slot. The operations of 1420 may be performed in accordance with examples as disclosed herein. In some examples, aspects of the operations of 1420 may be performed by a transition component 1135 as described with reference to FIG. 11.

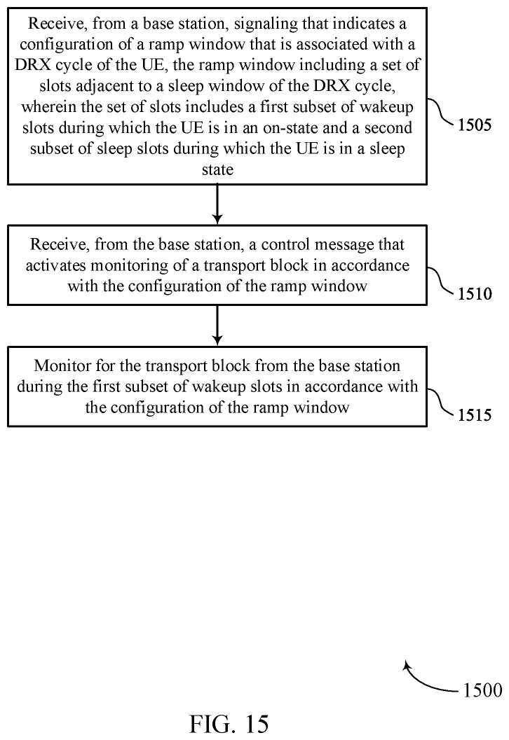

FIG. 15 shows a flowchart illustrating a method 1500 that supports DRX mode communication techniques in accordance with aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, signaling that indicates a configuration of a ramp window that is associated with a DRX cycle of the UE, the ramp window including a set of slots adjacent to a sleep window of the DRX cycle, where the set of slots includes a first subset of wakeup slots during which the UE is in an on-state and a second subset of sleep slots during which the UE is in a sleep state. The operations of 1505 may be performed in accordance with examples as disclosed herein. In some examples, aspects of the operations of 1505 may be performed by a ramp window component 1125 as described with reference to FIG. 11.

At 1510, the method may include receiving, from the base station, a control message that activates monitoring of a transport block in accordance with the configuration of the ramp window. The operations of 1510 may be performed in accordance with examples as disclosed herein. In some examples, aspects of the operations of 1510 may be performed by an activation component 1140 as described with reference to FIG. 11.

At 1515, the method may include monitoring for the transport block from the base station during the first subset of wakeup slots in accordance with the configuration of the ramp window. The operations of 1515 may be performed in accordance with examples as disclosed herein. In some examples, aspects of the operations of 1515 may be performed by a communication component 1130 as described with reference to FIG. 11.

The following provides an overview of aspects of the present disclosure:
Aspect 1: A method for wireless communication at a UE, comprising: receiving, from a base station, signaling that indicates a configuration of a ramp window that is associated with a discontinuous reception cycle of the UE, the ramp window including a set of slots adjacent to a sleep window of the discontinuous reception cycle, wherein the set of slots includes a first subset of wakeup slots during which the UE is in an on-state and a second subset of sleep slots during which the UE is in a sleep state; and monitoring for a transport block from the base station during the first subset of wakeup slots in accordance with the configuration of the ramp window.
Aspect 2: The method of aspect 1, further comprising: receiving the transport block during a wakeup slot of the first subset of wakeup slots based at least in part on the monitoring; and transitioning to an on-window of the discontinuous reception cycle based at least in part on receiving the transport block during the wakeup slot.
Aspect 3: The method of aspect 2, further comprising: initiating an inactivity timer associated with the discontinuous reception cycle in response to receiving the transport block during the wakeup slot, wherein an expiration of the inactivity timer indicates for the UE to transition to the sleep window.
Aspect 4: The method of aspect 1, wherein the set of slots occur before an on-window of the discontinuous reception cycle, the method comprising transitioning to the on-window of the discontinuous reception cycle based at least in part on failing to receive the transport block during the first subset of wakeup slots.
Aspect 5: The method of aspect 1, wherein the set of slots occur after an on-window of the discontinuous reception cycle, the method comprising transitioning to the sleep window of the discontinuous reception cycle based at least in part on failing to receive the transport block during the first subset of wakeup slots.
Aspect 6: The method of any of aspects 1 through 5, further comprising: receiving, from the base station, a control message that activates the monitoring of the transport block in accordance with the configuration of the ramp window.
Aspect 7: The method of any of aspects 1 through 6, wherein wakeup slots of the first subset of wakeup slots alternate with sleep slots of the second subset of sleep slots in time.
Aspect 8: The method of any of aspects 1 through 6, wherein the ramp window includes a first duration and a second duration, the first duration closer in time to an on-window of the discontinuous reception cycle than the second duration, and the first duration includes a first quantity of wakeup slots of the first subset of wakeup slots that is greater than a second quantity of wakeup slots of the first subset of wakeup slots included in the second duration based at least in part on the first duration being closer in time to the on-window of the discontinuous reception cycle.
Aspect 9: The method of any of aspects 1 through 6, wherein a location of the first subset of wakeup slots within the ramp window and a location of the second subset of sleep slots within the ramp window are based at least in part on a jitter of an uplink message transmitted by the UE, the jitter of the uplink message corresponding to a difference between an arrival time of the uplink message and a scheduled reception time of the uplink message.
Aspect 10: The method of aspect 9, wherein the configuration for the ramp window indicates a location of a first group of slots of the set of slots comprising a greater quantity of wakeup slots than sleep slots based at least in part on the jitter of the uplink message, and the configuration for the ramp window indicates a location of a second group of slots of the set of slots comprising a greater quantity of sleep slots than wakeup slots based at least in part on the jitter of the uplink message.
Aspect 11: The method of any of aspects 1 through 6, wherein the configuration for the ramp window indicates a location of a first group of slots of the set of slots comprising a greater quantity of wakeup slots than sleep slots, and wakeup slots of the first subset of wakeup slots and excluded from the first group of slots alternate in time with sleep slots of the second subset of sleep slots and excluded from the first group of slots.
Aspect 12: The method of any of aspects 1 through 11, wherein the signaling indicates a second configuration of a second ramp window associated with the discontinuous reception cycle, the second ramp window including a second set of slots outside the sleep window of the discontinuous reception cycle, and the second set of slots includes a third subset of wakeup slots and a fourth subset of sleep slots.
Aspect 13: The method of aspect 12, wherein the ramp window and the second ramp window are consecutive in time, and an on-window of the discontinuous reception cycle corresponds to the ramp window and the second ramp window.
Aspect 14: The method of any of aspects 1 through 13, wherein an on-window of the discontinuous reception cycle corresponds to the ramp window comprising the first subset of wakeup slots and the second subset of sleep slots.
Aspect 15: The method of any of aspects 1 through 14, wherein the set of slots is adjacent to an on-window of the discontinuous reception cycle.
Aspect 16: The method of any of aspects 1 through 15, wherein a quantity of slots included in the set of slots is based at least in part on a statistical probability that a downlink message scheduled for reception during an on-window of the discontinuous reception cycle is received outside of the on-window.
Aspect 17: An apparatus for wireless communication at a UE, comprising a processor; memory coupled with the processor; and instructions stored in the memory and executable by the processor to cause the apparatus to perform a method of any of aspects 1 through 16.
Aspect 18: An apparatus for wireless communication at a UE, comprising at least one means for performing a method of any of aspects 1 through 16.
Aspect 19: A non-transitory computer-readable medium storing code for wireless communication at a UE, the code comprising instructions executable by a processor to perform a method of any of aspects 1 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, signaling that indicates a configuration of a ramp window that is associated with a discontinuous reception cycle of the UE, the ramp window including a set of slots adjacent to a sleep window of the discontinuous reception cycle, wherein the set of slots includes a first subset of wakeup slots during which the UE is in an on-state and a second subset of sleep slots during which the UE is in a sleep state; and
monitoring for a transport block from the base station during the first subset of wakeup slots in accordance with the configuration of the ramp window.

2. The method of claim 1, further comprising:
receiving the transport block during a wakeup slot of the first subset of wakeup slots based at least in part on the monitoring; and
transitioning to an on-window of the discontinuous reception cycle based at least in part on receiving the transport block during the wakeup slot.

3. The method of claim 2, further comprising:
initiating an inactivity timer associated with the discontinuous reception cycle in response to receiving the transport block during the wakeup slot, wherein an expiration of the inactivity timer indicates for the UE to transition to the sleep window.

4. The method of claim 1, wherein the set of slots occur before an on-window of the discontinuous reception cycle, the method comprising:
transitioning to the on-window of the discontinuous reception cycle based at least in part on failing to receive the transport block during the first subset of wakeup slots.

5. The method of claim 1, wherein the set of slots occur after an on-window of the discontinuous reception cycle, the method comprising:
transitioning to the sleep window of the discontinuous reception cycle based at least in part on failing to receive the transport block during the first subset of wakeup slots.

6. The method of claim 1, further comprising:
receiving, from the base station, a control message that activates the monitoring of the transport block in accordance with the configuration of the ramp window.

7. The method of claim 1, wherein wakeup slots of the first subset of wakeup slots alternate with sleep slots of the second subset of sleep slots in time.

8. The method of claim 1, wherein:
the ramp window includes a first duration and a second duration, the first duration closer in time to an on-window of the discontinuous reception cycle than the second duration, and
the first duration includes a first quantity of wakeup slots of the first subset of wakeup slots that is greater than a second quantity of wakeup slots of the first subset of wakeup slots included in the second duration based at least in part on the first duration being closer in time to the on-window of the discontinuous reception cycle.

9. The method of claim 1, wherein a location of the first subset of wakeup slots within the ramp window and a location of the second subset of sleep slots within the ramp window are based at least in part on a jitter of an uplink message transmitted by the UE, the jitter of the uplink message corresponding to a difference between an arrival time of the uplink message and a scheduled reception time of the uplink message.

10. The method of claim 9, wherein:
the configuration for the ramp window indicates a location of a first group of slots of the set of slots comprising a greater quantity of wakeup slots than sleep slots based at least in part on the jitter of the uplink message, and
the configuration for the ramp window indicates a location of a second group of slots of the set of slots comprising a greater quantity of sleep slots than wakeup slots based at least in part on the jitter of the uplink message.

11. The method of claim 1, wherein the configuration for the ramp window indicates a location of a first group of slots of the set of slots comprising a greater quantity of wakeup slots than sleep slots, and wherein wakeup slots of the first subset of wakeup slots and excluded from the first group of slots alternate in time with sleep slots of the second subset of sleep slots and excluded from the first group of slots.

12. The method of claim 1, wherein the signaling indicates a second configuration of a second ramp window associated with the discontinuous reception cycle, the second ramp window including a second set of slots outside the sleep window of the discontinuous reception cycle, and wherein the second set of slots includes a third subset of wakeup slots and a fourth subset of sleep slots.

13. The method of claim 12, wherein the ramp window and the second ramp window are consecutive in time, and wherein an on-window of the discontinuous reception cycle corresponds to the ramp window and the second ramp window.

14. The method of claim 1, wherein an on-window of the discontinuous reception cycle corresponds to the ramp window comprising the first subset of wakeup slots and the second subset of sleep slots.

15. The method of claim 1, wherein the set of slots is adjacent to an on-window of the discontinuous reception cycle.

16. The method of claim 1, wherein a quantity of slots included in the set of slots is based at least in part on a statistical probability that a downlink message scheduled for reception during an on-window of the discontinuous reception cycle is received outside of the on-window.

17. An apparatus for wireless communication at a user equipment (UE), comprising:
a processor;
memory coupled with the processor; and
instructions stored in the memory and executable by the processor to cause the apparatus to:
receive, from a base station, signaling that indicates a configuration of a ramp window that is associated with a discontinuous reception cycle of the UE, the ramp window including a set of slots adjacent to a sleep window of the discontinuous reception cycle, wherein the set of slots includes a first subset of wakeup slots during which the UE is in an on-state and a second subset of sleep slots during which the UE is in a sleep state; and
monitor for a transport block from the base station during the first subset of wakeup slots in accordance with the configuration of the ramp window.

18. The apparatus of claim 17, wherein the instructions are further executable by the processor to cause the apparatus to:
receive the transport block during a wakeup slot of the first subset of wakeup slots based at least in part on the monitoring; and
transition to an on-window of the discontinuous reception cycle based at least in part on receiving the transport block during the wakeup slot.

19. The apparatus of claim 17, wherein the instructions are further executable by the processor to cause the apparatus to:
receive, from the base station, a control message that activates the monitoring of the transport block in accordance with the configuration of the ramp window.

20. The apparatus of claim 17, wherein wakeup slots of the first subset of wakeup slots alternate with sleep slots of the second subset of sleep slots in time.

21. The apparatus of claim 17, wherein:
the ramp window includes a first duration and a second duration, the first duration closer in time to an on-window of the discontinuous reception cycle than the second duration, and
the first duration includes a first quantity of wakeup slots of the first subset of wakeup slots that is greater than a second quantity of wakeup slots of the first subset of wakeup slots included in the second duration based at least in part on the first duration being closer in time to the on-window of the discontinuous reception cycle.

22. The apparatus of claim 17, wherein a location of the first subset of wakeup slots within the ramp window and a location of the second subset of sleep slots within the ramp window are based at least in part on a jitter of an uplink message transmitted by the UE, the jitter of the uplink message corresponding to a difference between an arrival time of the uplink message and a scheduled reception time of the uplink message.

23. The apparatus of claim 17, wherein:
the configuration for the ramp window indicates a location of a first group of slots of the set of slots comprising a greater quantity of wakeup slots than sleep slots, and
wakeup slots of the first subset of wakeup slots and excluded from the first group of slots alternate in time with sleep slots of the second subset of sleep slots and excluded from the first group of slots.

24. The apparatus of claim 17, wherein the signaling indicates a second configuration of a second ramp window associated with the discontinuous reception cycle, the second ramp window including a second set of slots outside the sleep window of the discontinuous reception cycle, and wherein the second set of slots includes a third subset of wakeup slots and a fourth subset of sleep slots.

25. The apparatus of claim 24, wherein the ramp window and the second ramp window are consecutive in time, and wherein an on-window of the discontinuous reception cycle corresponds to the ramp window and the second ramp window.

26. The apparatus of claim 17, wherein an on-window of the discontinuous reception cycle corresponds to the ramp window comprising the first subset of wakeup slots and the second subset of sleep slots.

27. The apparatus of claim 17, wherein the set of slots is adjacent to an on-window of the discontinuous reception cycle.

28. The apparatus of claim 17, wherein a quantity of slots included in the set of slots is based at least in part on a statistical probability that a downlink message scheduled for reception during an on-window of the discontinuous reception cycle is received outside of the on-window.

29. An apparatus for wireless communication at a user equipment (UE), comprising:
means for receiving, from a base station, signaling that indicates a configuration of a ramp window that is associated with a discontinuous reception cycle of the UE, the ramp window including a set of slots adjacent to a sleep window of the discontinuous reception cycle, wherein the set of slots includes a first subset of wakeup slots during which the UE is in an on-state and a second subset of sleep slots during which the UE is in a sleep state; and
means for monitoring for a transport block from the base station during the first subset of wakeup slots in accordance with the configuration of the ramp window.

30. A non-transitory computer-readable medium storing code for wireless communication at a user equipment (UE), the code comprising instructions executable by a processor to:
receive, from a base station, signaling that indicates a configuration of a ramp window that is associated with a discontinuous reception cycle of the UE, the ramp window including a set of slots adjacent to a sleep window of the discontinuous reception cycle, wherein the set of slots includes a first subset of wakeup slots during which the UE is in an on-state and a second subset of sleep slots during which the UE is in a sleep state; and
monitor for a transport block from the base station during the first subset of wakeup slots in accordance with the configuration of the ramp window.
